(19) United States
(12) Patent Application Publication
(10) Pub. No.: US 2026/0046868 A1
(43) Pub. Date: Feb. 12, 2026

(54) TECHNIQUES FOR JOINT NON-TERRESTRIAL NETWORKS AND AIRCRAFT RELAYING NETWORKS

(71) Applicant: QUALCOMM INCORPORATED, San Diego, CA (US)

(72) Inventors: Kangqi Liu, San Diego, CA (US); Hao Xu, Beijing (CN); Mingxi Yin, Beijing (CN); Ruiming Zheng, Beijing (CN); Qiaoyu Li, Beijing (CN)

(21) Appl. No.: 19/101,226

(22) PCT Filed: Sep. 23, 2022
(86) PCT No.: PCT/CN2022/120726

§ 371 Date: Feb. 4, 2025

(51) Int. Cl. H04W 72/20; H04W 36/08; H04W 72/51; H04W 72/566; H04W 84/06

(52) U.S. Cl. CPC H04W 72/20; H04W 36/08; H04W 72/51; H04W 72/566; H04W 84/06

(57) ABSTRACT

Methods, systems, and devices for wireless communications are described. A user equipment (UE) may be configured to receive a control message indicating a prioritization configuration for prioritizing wireless communications between one or more non-terrestrial relay nodes and one or more non-terrestrial network (NTN) nodes. The UE may be configured to communicate one or more messages based on the prioritization configuration and a quantity of non-terrestrial relay nodes corresponding to a location associated with the UE, a timing associated with the UE, or both.

### CROSS REFERENCE

The present Application is a 371 national stage filing of International PCT Application No. PCT/CN2022/120726 by Liu et al. entitled “TECHNIQUES FOR JOINT NON-TERRESTRIAL NETWORKS AND AIRCRAFT RELAYING NETWORKS,” filed Sep. 23, 2022, which is assigned to the assignee hereof, and which is expressly incorporated by reference in its entirety herein.

### INTRODUCTION

The following relates to wireless communications, including techniques for communications with non-terrestrial network (NTN) nodes and aircraft nodes.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

A method for wireless communication at a user equipment (UE) is described. The method may include receiving a control message indicating a prioritization configuration for prioritizing wireless communications between one or more non-terrestrial relay nodes and one or more non-terrestrial network (NTN) nodes. The method may further include communicating one or more messages based on the prioritization configuration and a quantity of non-terrestrial relay nodes corresponding to a location associated with the UE, a timing associated with the UE, or both.

An apparatus for wireless communication at a UE is described. The apparatus may include a processor and memory coupled with the processor, the processor configured to receive a control message indicating a prioritization configuration for prioritizing wireless communications between one or more non-terrestrial relay nodes and one or more NTN nodes. The processor may be further configured to communicate one or more messages based on the prioritization configuration and a quantity of non-terrestrial relay nodes corresponding to a location associated with the UE, a timing associated with the UE, or both.

Another apparatus for wireless communication at a UE is described. The apparatus may include means for receiving a control message indicating a prioritization configuration for prioritizing wireless communications between one or more non-terrestrial relay nodes and one or more NTN nodes. The apparatus may further include means for communicating one or more messages based on the prioritization configuration and a quantity of non-terrestrial relay nodes corresponding to a location associated with the UE, a timing associated with the UE, or both.

A non-transitory computer-readable medium storing code for wireless communication at a UE is described. The code may include instructions executable by a processor to receive a control message indicating a prioritization configuration for prioritizing wireless communications between one or more non-terrestrial relay nodes and one or more NTN nodes. The instructions may be further executable to communicate one or more messages based on the prioritization configuration and a quantity of non-terrestrial relay nodes corresponding to a location associated with the UE, a timing associated with the UE, or both.

Some examples of the method, apparatuses, and non-transitory computer-readable medium described herein may further include operations, features, means, or instructions for prioritizing wireless communications with the one or more non-terrestrial relay nodes or the one or more NTN nodes based on the quantity of non-terrestrial relay nodes in accordance with the prioritization configuration, where the one or more messages may be communicated with a non-terrestrial relay node of the one or more non-terrestrial relay nodes or an NTN node of the one or more NTN nodes in accordance with the prioritization.

Some examples of the method, apparatuses, and non-transitory computer-readable medium described herein may further include operations, features, means, or instructions for prioritizing wireless communications with the one or more non-terrestrial relay nodes or the one or more NTN nodes based on a comparison between the quantity of non-terrestrial relay nodes and a threshold quantity.

Some examples of the method, apparatuses, and non-transitory computer-readable medium described herein may further include operations, features, means, or instructions for prioritizing wireless communications with the one or more non-terrestrial relay nodes based on the quantity of non-terrestrial relay nodes being greater than or equal to the threshold quantity and prioritizing wireless communications with the one or more NTN nodes based on the quantity of non-terrestrial relay nodes being less than the threshold quantity.

Some examples of the method, apparatuses, and non-transitory computer-readable medium described herein may further include operations, features, means, or instructions for receiving, via the control message, an indication of the threshold quantity, where the comparison may be based on the control message.

Some examples of the method, apparatuses, and non-transitory computer-readable medium described herein may further include operations, features, means, or instructions for determining a distance metric between the UE and the quantity of non-terrestrial relay nodes within a target area of the location associated with the UE, where the prioritization may be based on the distance metric.

Some examples of the method, apparatuses, and non-transitory computer-readable medium described herein may further include operations, features, means, or instructions for receiving, via the control message, an indication of the target area.

Some examples of the method, apparatuses, and non-transitory computer-readable medium described herein may further include operations, features, means, or instructions for monitoring for a synchronization signal block, a discovery message, or both, from the one or more non-terrestrial relay nodes or the one or more NTN nodes based on the prioritization configuration and the quantity of non-terrestrial relay nodes, where communicating the one or more messages may be based on the monitoring.

Some examples of the method, apparatuses, and non-transitory computer-readable medium described herein may further include operations, features, means, or instructions for receiving, via the control message, an indication of a model for estimation of the quantity of non-terrestrial relay nodes within a target area of the location associated with the UE and estimating the quantity of non-terrestrial relay nodes within the target area of the UE in accordance with the model, where the one or more messages may be communicated based on the estimation.

Some examples of the method, apparatuses, and non-transitory computer-readable medium described herein may further include operations, features, means, or instructions for communicating the one or more messages with an NTN node of the one or more NTN nodes, performing a handover procedure from the NTN node to a non-terrestrial relay node of the one or more non-terrestrial relay nodes based on the quantity of non-terrestrial relay nodes, and communicating one or more additional messages with the non-terrestrial relay node based on the handover procedure.

Some examples of the method, apparatuses, and non-transitory computer-readable medium described herein may further include operations, features, means, or instructions for communicating the one or more messages includes receiving the one or more messages from the NTN node, the one or more messages include information associated with the non-terrestrial relay node, the handover procedure may be performed based on the information, and the information includes an identifier associated with the non-terrestrial relay node, a communication parameter for communicating with the non-terrestrial relay node, a heading associated with the non-terrestrial relay node, a location associated with the non-terrestrial relay node, or any combination thereof.

Some examples of the method, apparatuses, and non-transitory computer-readable medium described herein may further include operations, features, means, or instructions for communicating the one or more messages includes receiving the one or more messages from the non-terrestrial relay node, the one or more messages include information associated with the NTN node, the handover procedure may be performed based on the information, and the information includes an identifier associated with the NTN node, communications parameters for communicating with the NTN node, a location associated with the NTN node, or any combination thereof.

Some examples of the method, apparatuses, and non-transitory computer-readable medium described herein may further include operations, features, means, or instructions for communicating the one or more messages with a non-terrestrial relay node of the one or more non-terrestrial relay nodes, performing one or more measurements associated with the one or more messages communicated with the non-terrestrial relay node, performing a handover procedure from the non-terrestrial relay node to an NTN node of the one or more NTN nodes based on the one or more measurements and a measurement threshold, and communicating one or more additional messages with the NTN node based on the handover procedure.

Some examples of the method, apparatuses, and non-transitory computer-readable medium described herein may further include operations, features, means, or instructions for transmitting a capability message indicating a capability of the UE to perform wireless communications with the one or more non-terrestrial relay nodes and the one or more NTN nodes, where the control message indicating the prioritization configuration may be received based on the capability message.

Some examples of the method, apparatuses, and non-transitory computer-readable medium described herein may further include operations, features, means, or instructions for communicating the one or more messages with an additional wireless device via a relay link provided by a non-terrestrial relay node of the one or more non-terrestrial relay nodes or an NTN node of the one or more NTN nodes.

In some examples of the method, apparatuses, and non-transitory computer-readable medium described herein, the one or more non-terrestrial relay nodes include an aircraft, an unmanned aerial vehicle (UAV), a high-altitude platform (HAP) device, or any combination thereof and the NTN node includes a satellite.

A method for wireless communication at a UE is described. The method may include performing an access procedure in accordance with a prioritization configuration associated with the access procedure, the prioritization configuration indicating a priority list including respective priorities for terrestrial network entities, non-terrestrial relay nodes, and NTN nodes. The method may further include communicating one or more messages with one of the terrestrial network entity, the non-terrestrial relay node, or the NTN node based on the access procedure.

An apparatus for wireless communication at a UE is described. The apparatus may include a processor and memory coupled with the processor, the processor configured to perform an access procedure in accordance with a prioritization configuration associated with the access procedure, the prioritization configuration indicating a priority list including respective priorities for terrestrial network entities, non-terrestrial relay nodes, and NTN nodes. The processor may be further configured to communicate one or more messages with one of the terrestrial network entity, the non-terrestrial relay node, or the NTN node based on the access procedure.

Another apparatus for wireless communication at a UE is described. The apparatus may include means for performing an access procedure in accordance with a prioritization configuration associated with the access procedure, the prioritization configuration indicating a priority list including respective priorities for terrestrial network entities, non-terrestrial relay nodes, and NTN nodes. The apparatus may further include means for communicating one or more messages with one of the terrestrial network entity, the non-terrestrial relay node, or the NTN node based on the access procedure.

A non-transitory computer-readable medium storing code for wireless communication at a UE is described. The code may include instructions executable by a processor to perform an access procedure in accordance with a prioritization configuration associated with the access procedure, the prioritization configuration indicating a priority list including respective priorities for terrestrial network entities, non-terrestrial relay nodes, and NTN nodes. The instructions may be further executable to and communicate one or more messages with one of the terrestrial network entity, the non-terrestrial relay node, or the NTN node based on the access procedure.

In some examples of the method, apparatuses, and non-transitory computer-readable medium described herein, the prioritization configuration indicates a first priority associated with terrestrial network entities and the method, apparatuses, and non-transitory computer-readable medium may include further operations, features, means, or instructions for prioritizing wireless communications with the terrestrial network entity, the non-terrestrial relay node, or the NTN node based on a comparison of the first priority, the second priority, and the third priority.

Some examples of the method, apparatuses, and non-transitory computer-readable medium described herein may further include operations, features, means, or instructions for monitoring for a synchronization signal block, a discovery message, or both, from the terrestrial network entity, the non-terrestrial relay node, and the NTN node according to respective periodicities that may be based on the respective priorities indicated via the prioritization configuration, where communicating the one or more messages may be based on the monitored synchronization signal blocks, discovery messages, or both.

In some examples of the method, apparatuses, and non-transitory computer-readable medium described herein, the access procedure includes a discovery procedure, an initial access procedure, or both.

In some examples of the method, apparatuses, and non-transitory computer-readable medium described herein, the one or more non-terrestrial relay nodes include an aircraft, a UAV, a HAP device, or any combination thereof and the NTN node includes a satellite.

A method for wireless communication at a network entity is described. The method may include outputting a control message indicating a prioritization configuration associated with prioritization of wireless communications at a UE, the prioritization configuration indicating relative priorities associated with at least non-terrestrial relay nodes and NTN nodes. The method may further include outputting or obtaining one or more messages via a relay link provided by a non-terrestrial relay node or an NTN node based on the prioritization configuration.

An apparatus for wireless communication at a network entity is described. The apparatus may include a processor and memory coupled with the processor, the processor configured to output a control message indicating a prioritization configuration associated with prioritization of wireless communications at a UE, the prioritization configuration indicating relative priorities associated with at least non-terrestrial relay nodes and NTN nodes. The processor may be further configured to output or obtain one or more messages via a relay link provided by a non-terrestrial relay node or an NTN node based on the prioritization configuration.

Another apparatus for wireless communication at a network entity is described. The apparatus may include means for outputting a control message indicating a prioritization configuration associated with prioritization of wireless communications at a UE, the prioritization configuration indicating relative priorities associated with at least non-terrestrial relay nodes and NTN nodes. The apparatus may further include means for outputting or obtaining one or more messages via a relay link provided by a non-terrestrial relay node or an NTN node based on the prioritization configuration.

A non-transitory computer-readable medium storing code for wireless communication at a network entity is described. The code may include instructions executable by a processor to output a control message indicating a prioritization configuration associated with prioritization of wireless communications at a UE, the prioritization configuration indicating relative priorities associated with at least non-terrestrial relay nodes and NTN nodes. The instructions may be further executable to output or obtain one or more messages via a relay link provided by a non-terrestrial relay node or an NTN node based on the prioritization configuration.

Some examples of the method, apparatuses, and non-transitory computer-readable medium described herein may further include operations, features, means, or instructions for outputting, via the control message, an indication of a threshold quantity of non-terrestrial relay nodes, where the outputting or obtaining the one or more messages may be based on a quantity of non-terrestrial relay nodes within a target area of the UE and the threshold quantity of non-terrestrial relay nodes.

Some examples of the method, apparatuses, and non-transitory computer-readable medium described herein may further include operations, features, means, or instructions for outputting, via the control message, an indication of the target area, where the outputting or obtaining the one or more messages may be based on outputting the indication of the target area.

Some examples of the method, apparatuses, and non-transitory computer-readable medium described herein may further include operations, features, means, or instructions for outputting, via the control message, an indication of a model for estimating the quantity of non-terrestrial relay nodes within the target area of the UE, where the outputting or obtaining the one or more messages may be based on outputting the indication of the model.

In some examples of the method, apparatuses, and non-transitory computer-readable medium described herein, the prioritization configuration indicates a fixed priority list including respective priorities associated with terrestrial network entities, non-terrestrial relay nodes, and NTN nodes and the outputting or obtaining the one or more messages may be based on the respective priorities.

In some examples of the method, apparatuses, and non-transitory computer-readable medium described herein, the one or more non-terrestrial relay nodes include an aircraft, a UAV, a HAP device, or any combination thereof and the NTN node includes a satellite.

### BRIEF DESCRIPTION OF THE DRAWINGS

FIG. 1 illustrates an example of a wireless communications system that supports techniques for joint NTNs and aircraft relaying networks in accordance with one or more aspects of the present disclosure.

FIG. 2 illustrates an example of a network architecture that supports techniques for joint NTNs and aircraft relaying networks in accordance with one or more aspects of the present disclosure.

FIG. 3 illustrates an example of a wireless communications system that supports techniques for joint NTNs and aircraft relaying networks in accordance with one or more aspects of the present disclosure.

FIGS. 4A and 4B illustrate examples of wireless communications systems that support techniques for joint NTNs and aircraft relaying networks in accordance with one or more aspects of the present disclosure.

FIGS. 5A and 5B illustrates examples of wireless communications systems that support techniques for joint NTNs and aircraft relaying networks in accordance with one or more aspects of the present disclosure.

FIG. 6 illustrates an example of a process flow that supports techniques for joint NTNs and aircraft relaying networks in accordance with one or more aspects of the present disclosure.

FIGS. 7 and 8 show block diagrams of devices that support techniques for joint NTNs and aircraft relaying networks in accordance with one or more aspects of the present disclosure.

FIG. 9 shows a block diagram of a communications manager that supports techniques for joint NTNs and aircraft relaying networks in accordance with one or more aspects of the present disclosure.

FIG. 10 shows a diagram of a system including a device that supports techniques for joint NTNs and aircraft relaying networks in accordance with one or more aspects of the present disclosure.

FIGS. 11 and 12 show block diagrams of devices that support techniques for joint NTNs and aircraft relaying networks in accordance with one or more aspects of the present disclosure.

FIG. 13 shows a block diagram of a communications manager that supports techniques for joint NTNs and aircraft relaying networks in accordance with one or more aspects of the present disclosure.

FIG. 14 shows a diagram of a system including a device that supports techniques for joint NTNs and aircraft relaying networks in accordance with one or more aspects of the present disclosure.

FIGS. 15 through 18 show flowcharts illustrating methods that support techniques for joint NTNs and aircraft relaying networks in accordance with one or more aspects of the present disclosure.

### DETAILED DESCRIPTION

Some wireless communications systems may include non-terrestrial entities, such as aircraft, UAVs, zeppelins, satellites, etc. In some cases, wireless devices (e.g., UEs) may be able to communicate with non-terrestrial entities when the wireless devices are out of cellular coverage of terrestrial network entities, such as base stations or other network entities. In such cases, the UEs may be able to connect to non-terrestrial entities so that the non-terrestrial entities may relay wireless communications to and from the UEs. For the purposes of the present disclosure, different types of non-terrestrial entities may be referred to as non-terrestrial relay nodes (e.g., aircrafts, UAVs, etc.) or NTN nodes (e.g., satellites). Non-terrestrial relay nodes may act as UEs, integrated access and backhaul (IAB) nodes, network entities, or any combination thereof, and may be configured to relay communications between wireless devices, such as between UEs and terrestrial entities, other non-terrestrial entities, or both. NTN nodes may include non-terrestrial entities, such as satellites, which are associated with an NTN and which may be communicatively coupled to terrestrial entities such as NTN gateways.

There may be tradeoffs with communications with different types of non-terrestrial entities. For example, satellites may provide larger coverage areas (e.g., less frequent handovers). However, UEs may utilize an increased transmit power (and therefore power consumption) when transmitting messages to satellites as compared to a transmit power used to transmit messages to other types of devices, such as terrestrial network entities and/or aircraft. Further, communications with aircrafts may be more cost and energy efficient as compared to communications with satellites (e.g., lower transmit power), but may support smaller coverage areas, which may result in more frequent handovers. Moreover, aircraft density may vary depending on geographical location and time (e.g., fewer aircraft at night, fewer aircraft in rural areas vs. urban areas). Some techniques do not provide rules or conditions that control what types of non-terrestrial entities that UEs are expected to communicate with. Without explicit rules or conditions used to determine what types of wireless devices to communicate with, UEs may attempt to perform communications with aircraft in cases where the UE would be better suited to perform communications with sateliites, or vice versa, which may lead to unsuccessful discovery procedures, wasted communication resources and increased power consumption at the UEs.

Accordingly, one or more aspects of the present disclosure are directed to prioritization configurations that may be used to define relative priorities of non-terrestrial entities. For instance, one or more aspects of the present disclosure may enable UEs to be configured with prioritization configurations for communicating with aircrafts, satellites, or both. In some implementations, the prioritization configurations define rules or conditions that can be used to determine whether UEs will prioritize wireless communications with aircraft (e.g., non-terrestrial relay nodes) over satellites (e.g., NTN nodes), or vice versa. For example, in some cases, prioritization configurations may cause UEs to perform initial access procedures and/or discovery procedures with satellites and aircraft according to different periodicities.

In some implementations, a prioritization configuration may define a fixed priority list which includes relative priorities for different types of wireless nodes (e.g., one example fixed priority list may prioritize terrestrial nodes over aircraft, and prioritize aircraft over satellites). In such cases, the priority list may be signaled to the UE, or pre-defined at the UE. In other implementations, the prioritization configuration may include a variable priority that is based on the number of aircraft near the UE. For example, the prioritization configuration may cause the UE to prioritize communications with aircraft over communications with satellites if the number of aircrafts in the vicinity (e.g., within a target area or target radius) of the UE is greater than some threshold. Further, the prioritization configuration may enable the UE to prioritize communications with satellites over communications with aircraft (e.g., if the number of aircraft in a target radius or target area relative to the UE is less than the threshold).

As will be described in further detail herein, the threshold quantity of aircraft may be configured at the UE, signaled to the UE (e.g., by a network entity), or both. Moreover, the threshold quantity of aircraft may be determined or modified based on one or more parameters including network conditions, latency/performance requirements at the UE (e.g., quality of service (QOS) metrics), and the like.

Techniques described herein may enable wireless devices (e.g., UEs) to determine what types of non-terrestrial entities the wireless devices may prioritize in different scenarios. In particular, the prioritization configurations described herein may cause wireless devices to prioritize different types of non-terrestrial entities in different situations based on what type of non-terrestrial entity is expected or more likely to exhibit better wireless communication performance with the wireless device. In this regard, techniques described herein may enable wireless devices to establish wireless communications with different types of non-terrestrial entities in such a manner as to improve an efficiency and reliability of wireless communications between the wireless device and respective non-terrestrial entities.

Aspects of the disclosure are initially described in the context of wireless communications systems. Aspects of the disclosure are additionally described in the context of an example process flow: Aspects of the disclosure are further illustrated by and described with reference to apparatus diagrams, system diagrams, and flowcharts that relate to techniques for joint NTNs and aircraft relaying networks.

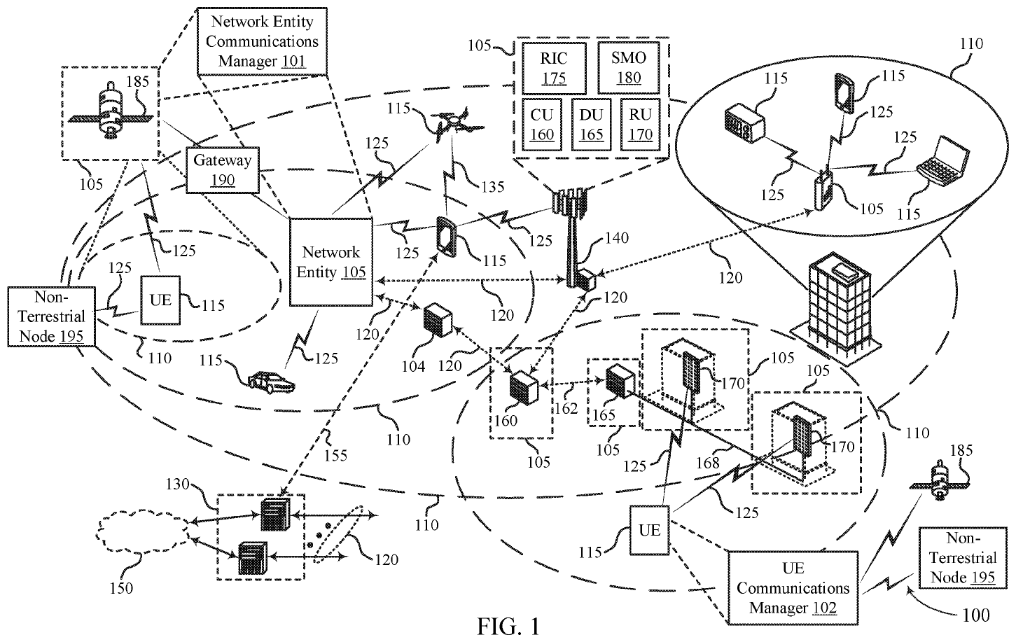

FIG. 1 illustrates an example of a wireless communications system 100 that supports techniques for joint NTNs and aircraft relaying networks in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node, which may be referred to as a node, a network node, a network entity 105, or a wireless node, may be a base station 140 (e.g., any base station 140 described herein), a UE 115 (e.g., any UE 115 described herein), a network controller, an apparatus, a device, a computing system, one or more components, and/or another suitable processing entity configured to perform any of the techniques described herein. For example, a network node may be a UE 115. As another example, a network node may be a network entity 105 or a base station 140. As another example, a first network node may be configured to communicate with a second network node or a third network node. In one aspect of this example, the first network node may be a UE 115, the second network node may be a base station 140, and the third network node may be a UE 115. In another aspect of this example, the first network node may be a UE 115, the second network node may be a base station 140, and the third network node may be a base station 140. In yet other aspects of this example, the first, second, and third network nodes may be different relative to these examples. Similarly, reference to a UE 115, base station 140, apparatus, device, computing system, or the like may include disclosure of the UE 115, base station 140, apparatus, device, computing system, or the like being a network node. For example, disclosure that a UE 115 is configured to receive information from a base station 140 also discloses that a first network node is configured to receive information from a second network node. Consistent with this disclosure, once a specific example is broadened in accordance with this disclosure (e.g., a UE 115 is configured to receive information from a base station also discloses that a first network node is configured to receive information from a second network node), the broader example of the narrower example may be interpreted in the reverse, but in a broad open-ended way. In the example above where a UE 115 being configured to receive information from a base station 140 also discloses that a first network node being configured to receive information from a second network node, the first network node may refer to a first UE 115, a first base station 140, a first apparatus, a first device, a first computing system, a first one or more components, a first processing entity, or the like configured to receive the information; and the second network node may refer to a second UE 115, a second base station 140, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an IAB network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support paging message communication in an NTN as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrow band IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The electromagnetic spectrum is often subdivided, based on frequency/wavelength, into various classes, bands, channels, etc. In 5G NR two initial operating bands have been identified as frequency range designations FR1 (410 MHZ-7.125 GHz) and FR2 (24.25 GHZ-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHZ” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beam forming operations. For example, a network entity 105 may use multiple antennas or antenna array's (e.g., antenna panels) to conduct beamforming operations for directional communications with a UE 115. Some signals (e.g., synchronization signals, reference signals, beam selection signals, or other control signals) may be transmitted by a network entity 105 multiple times in different directions. For example, the network entity 105 may transmit a signal according to different beamforming weight sets associated with different directions of transmission. Transmissions in different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a network entity 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the network entity 105 in different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or radio frequency beamforming to generate a combined beam for transmission (e.g., from a network entity 105 to a UE 115). The UE 115 may report feedback that indicates precoding weights for one or more beam directions, and the feedback may correspond to a configured number of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a network entity 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the network entity 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a network entity 105 or a core network 130 supporting radio bearers for user plane data. At the physical layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The wireless communications system 100 may support NTN communications between network nodes of the wireless communications system 100. For example, the wireless communications system 100 may be an example of an NTN that supports communications between NTN nodes and terrestrial network nodes. For instance, as described herein, a network entity 105 may refer to a terrestrial communication device (such as a base station 140) or a non-terrestrial communication device (such as a satellite 185, a balloon, a drone, a non-terrestrial node 195, a high-altitude platform (HAP) station, or another non-terrestrial device). A NTN network entity 105 may be connected to (e.g., communicate with) a terrestrial network entity 105 via a gateway 190. In some examples, a NTN network entity 105 may correspond to a first cell type (e.g., an NTN cell type), and a terrestrial network entity 105 may correspond to a second cell type (e.g., a terrestrial cell type) different from the first cell type.

In some examples, a NTN network entity 105 may provide coverage to areas in which a terrestrial network entity 105 may be unavailable. A channel corresponding to the NTN network entity 105 may be characterized with strong line of sight conditions, as a signal provided by the NTN network entity 105 may be reflected at the sky (e.g., as opposed to a signal corresponding to a terrestrial network entity 105 which may travel over a ground surface). A footprint of a beam radiated from the NTN network entity 105 may have a relatively clear boundary (e.g., as compared to terrestrial network entity 105 beam boundaries), and a UE 115 may be likely to operate within a single beam serving area (e.g., except in cases where a UE 115 is located at the boundary between two serving areas). In some examples, a serving area for a beam corresponding to the NTN network entity 105 may be larger than a serving area for a beam corresponding to a terrestrial network entity 105.

An NTN network entity 105, such as a satellite 185, may move over time and support various coverage scenarios. For example, the NTN network entity 105 may support a moving cell or beam coverage scenario in which the cell footprint or beam footprint moves together with the satellite 185. Alternatively, the NTN network entity 105 may support a quasi-earth fixed cell or beam coverage scenario in which the cell footprint of beam footprint remains static for a period of time as the NTN network entity 105 moves through space.

Additionally, or alternatively, the wireless communications system 100 may support one or more non-terrestrial nodes 195. For the purposes of the present disclosure, non-terrestrial nodes 195 may include, but are not limited to, aircraft, UAVs, drones, HAPs, and the like. For example, as shown in FIG. 1, a UE 115 may be communicatively coupled to a satellite 185 (e.g., NTN node), a non-terrestrial node 195, or both, via one or more communication links 125.

A network entity 105 may include a network entity communications manager 101 to manage communications between the network entity 105 and other devices in the wireless communications system 100. In a similar manner, a UE communications manager 102 may manage communications between a UE 115 and other devices in the wireless communications system 100.

In some aspects, the wireless communications system 100 may support prioritization configurations that are used to define relative priorities of non-terrestrial entities. In particular, techniques described herein may enable UEs 115 of the wireless communications system 100 to be configured with prioritization configurations that define rules or conditions that are used to determine whether UEs 115 are expected to prioritize wireless communications with aircraft (e.g., non-terrestrial relay nodes) over satellites (e.g., NTN nodes), or vice versa.

In some implementations, a prioritization configuration may define a fixed priority list which includes relative priorities for different types of wireless nodes (e.g., fixed priority may prioritize terrestrial nodes over aircraft, and prioritize aircraft over satellites). In such cases, the priority list may be signaled to the UE 115, or pre-defined at the UE 115. In other implementations, the prioritization configuration may include a variable priority that is based on the number of aircraft near the UE 115. For example, the prioritization configuration may cause the UE 115 to prioritize communications with aircraft over communications with satellites if the number of aircraft in the vicinity of the UE 115 is greater than some threshold. Further, the prioritization configuration may cause the UE 115 to prioritize communications with satellites over communications with aircraft if the number of aircraft in the vicinity of the UE 115 is less than the threshold.

Techniques described herein may enable wireless devices (e.g., UEs 115) to determine what types of non-terrestrial entities the wireless devices are expected to prioritize in different scenarios. In particular, the prioritization configurations described herein may cause wireless devices to prioritize different types of non-terrestrial entities in different situations based on what type of non-terrestrial entity is expected or more likely to exhibit better wireless communication performance with the wireless device. In this regard, techniques described herein may enable wireless devices to establish wireless communications with different types of non-terrestrial entities in such a manner as to improve an efficiency and reliability of wireless communications between the wireless device and respective non-terrestrial entities.

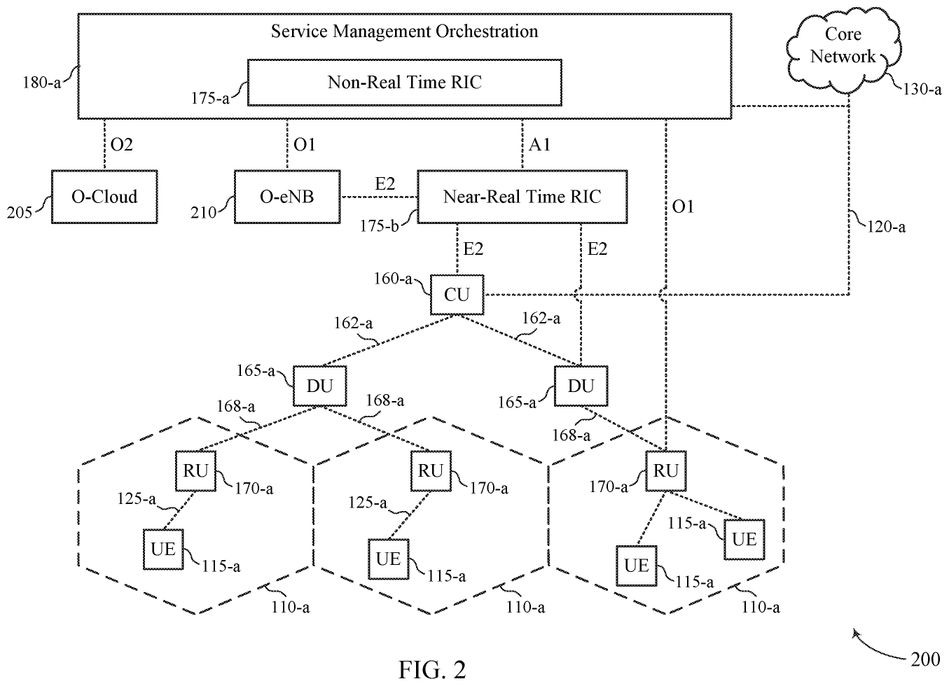

FIG. 2 illustrates an example of a network architecture 200 (e.g., a disaggregated base station architecture, a disaggregated RAN architecture) that supports techniques for joint NTNs and aircraft relaying networks in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an AI interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., AI policies).

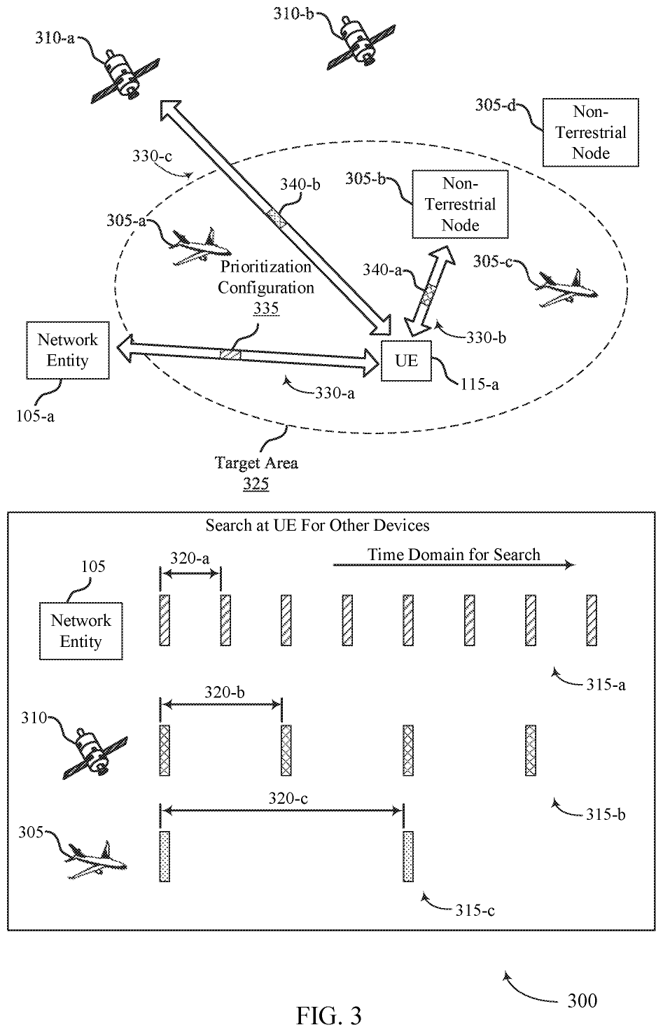

FIG. 3 illustrates an example of a wireless communications system 300 that supports techniques for joint NTNs and aircraft relaying networks in accordance with one or more aspects of the present disclosure. In some examples, the wireless communications system 300 may implement aspects of the wireless communications system 100, the network architecture 200, or both. For example, the wireless communications system 300 may support prioritization configurations that enable wireless devices to prioritize different types of non-terrestrial entities, as described with reference to FIG. 1.

The wireless communications system 300 may include a UE 115-a, a network entity 105-a, one or more aircraft 305-a, 305-b, 305-c, and 305-d (e.g., non-terrestrial relay nodes), and one or more satellites 310-a, 310-b (e.g., NTN nodes). In this regard, the wireless communications system 300 may include an example of an NTN. The UE 115-a may communicate with the respective devices (e.g., network entity 105-a, aircraft 305, satellites 310) using one or more communication links. For example, the UE 115-a may communicate with the network entity 105-a via a communication link 330-a, where the communication link 330-a may include an example of an access link (e.g., Uu link). The communication link 330-a may include a bi-directional link that can include both uplink and downlink communication. For example, the UE 115-a may transmit uplink transmissions, such as uplink control signals or uplink data signals, to the network entity 105-a via communication link 330-a, and the network entity 105-a may transmit downlink transmissions, such as downlink control signals or downlink data signals, to the UE 115-a via the communication link 330-a.

Similarly, the UE 115-a may be configured to establish communication links with one or more of the aircraft 305, satellites 310, or both. In such cases, communication links 330 (e.g., communication links 330-b, 330-c) between the UE 115-a and the aircraft 305, satellites 310, or both, may be examples of Uu links, sidelinks (e.g., PC5 links), relay links, IAB backhaul links, or any combination thereof. In some cases, the type of entity that the UE 115-a is communicating with (e.g., network entity 105-a, aircraft 305, satellite 310) may or may not be transparent to the UE 115-a. Moreover, the aircraft 305 and satellites 310 may be configured to communicate with one another. For example, some aircraft 305 are expected to support both satellite-based and air-to-ground (ATG)-based communications.

In some aspects, the satellites 310 may be associated with one or more NTN gateways, where the NTN gateways may be positioned on the ground or in the air (e.g., airborne, in space, etc.). For example, the first satellite 310-a may be associated with a terrestrial NTN gateway, where the NTN gateway is communicatively couplable to the network entity 105-a. In this example, the NTN gateway may facilitate communications to and from the satellite 310-a via a feeder link between the NTN gateway and the satellite 310-a.

In this regard, the wireless communications system 300 may include an example of a heterogeneous network in which a terrestrial infrastructure (e.g., network entity 105-a) is complemented and supplemented by non-terrestrial nodes (e.g., NTN). As will be described in further detail herein, NTNs may facilitate synchronization, scheduling, HARQ, and mobility within the wireless communications system 300.

In some aspects, an NTN (e.g., wireless communications system 300) may include different types of non-terrestrial entities, such as UAVs, HAP stations or devices, aircraft 305, and satellites 310, such as low-earth orbit (LEO) satellites, medium-earth orbit (MEO) satellites, and geostationary-earth orbit (GEO) satellites. Respective non-terrestrial entities may operate at varying altitudes. For example, UAVs may operate at an altitude of approximately 100 meters, where HAPs may operate at an altitude between ten and twenty kilometers (km), and aircraft may operate at an altitude between nine and twelve km. Similarly, LEO satellites may operate at an altitude of 500-1,200 km, MEO satellites may operate at an altitude of 5,000-2,500 km, and GEO satellites may operate at an altitude of 36,000 km or more.

The varying altitudes at which the respective non-terrestrial nodes operate may result in varying sized coverage areas supported by the respective non-terrestrial nodes. For example, a UAV may operate at a lower altitude as compared to a LEO satellite, and may therefore support a smaller coverage area (e.g., smaller cell) as compared to the LEO satellite. Similarly, the LEO satellite may operate at a lower altitude as compared to a GEO satellite, and may therefore support a smaller coverage area (e.g., smaller cell) as compared to the GEO satellite.

Communications between the UE 115-a and/or the network entity 105-a and non-terrestrial nodes (e.g., aircraft 305, satellites 310) may be referred to as ATG communications. ATG communications and network evolution may enable wireless communications to be relayed by the non-terrestrial nodes for non-cellular coverage areas. The wireless communications system 300 may exhibit coexistence between ATG and an international mobile telecommunications (IMT) terrestrial network, where the non-terrestrial nodes may exhibit large inter-site distances (ISDs) and coverage ranges (e.g., 300 km).

In some implementations, non-terrestrial nodes such as commercial aircraft 305 and satellites 310 may be used to extend coverage areas of the wireless communications system 300 that would otherwise not be reachable via terrestrial nodes, such as the network entity 105-a. In other words, the UE 115-a may be able to communicate with non-terrestrial entities (e.g., aircraft 305, satellites 310) when the UE 115-a is out of cellular coverage with respect to the network entity 105-a. In such cases, the UE 115-a may be able to connect to non-terrestrial entities so that the non-terrestrial entities may relay wireless communications to and from the UE 115-a. Such relay capabilities enabled by non-terrestrial entities may facilitate SoS message delivery and data communications (e.g., emergency communications) in non-cellular coverage areas, and enable universal cellular coverage. For example, in cases where the UE 115-a is out of coverage from the network entity 105-a, the UE 115-a may be able to transmit an SoS message to an aircraft 305, where the aircraft is configured to relay the SoS message to the network entity 105-a.

However, communications with different types of non-terrestrial entities may be associated with respective tradeoffs. For example, NTN nodes, such as satellites 310, may provide larger coverage areas (e.g., less frequent handovers), but may increase a transmit power (and therefore power consumption) associated with messages transmitted from the UE 115-a to the satellite 310. Further, the use of satellite 310 relays may require additional satellites to be manufactured and launched, which may be cost prohibitive in some cases and locations. Further, communications between the UE 115-a and an aircraft 305 may be more cost and energy efficient as compared to communications with satellites 310 (e.g., lower transmit power). However, aircraft 305 may exhibit smaller coverage areas as compared to satellites 310, which may result in more frequent handovers. Moreover, aircraft density may vary depending on geographical location and time (e.g., fewer aircraft at night).

Some wireless communications systems do not provide rules or conditions that control what types of non-terrestrial entities that UEs 115 are expected to communicate with. Without explicit rules or conditions used to determine what types of wireless devices to communicate with, UEs 115 perform unsuccessful discovery procedures, which may lead to wasted communication resources and increased power consumption at the UEs 115.

Accordingly, aspects of the present disclosure are directed to techniques for joint NTN and aircraft relaying networks that enable communications with both NTN and aircraft relaying. In particular, techniques described herein are directed to prioritization configurations 335 that are used to define relative priorities of non-terrestrial entities. Stated differently, the UE 115-a may be configured with prioritization configurations 335 that define rules or conditions that are used to determine whether the UE 115-a is expected to prioritize wireless communications with aircraft 305 (e.g., non-terrestrial relay nodes) over satellites 310 (e.g., NTN nodes), or vice versa.

According to techniques described herein, prioritization configurations 335 may cause the UE 115-a to prioritize different types of non-terrestrial nodes over others in different circumstances according to a variety of considerations or parameters. Parameters that may be taken into account when prioritizing different types of non-terrestrial nodes may include, but are not limited to, different priorities for different network connections (e.g., fixed priority, dynamic priority), satellite-to-aircraft switching (e.g., location-based triggering from satellite 310 to aircraft 305, RSRP-based switching from aircraft 305 to satellite 310), different aircraft types (e.g., aircraft 305 operating as a gNB, IAB, or UE feature and different options of types of interfaces), and the like.

For example, referring to the wireless communications system 300, the UE 115-a may be configured with a prioritization configuration 335 for prioritizing wireless connections with different types of wireless entities, such as terrestrial entities (e.g., network entity 105-a), non-terrestrial relay nodes (e.g., aircraft 305), NTN nodes (e.g., satellites 310), or any combination thereof. The prioritization configuration 335 may be pre-configured at the UE 115-a, signaled to the UE 115-a, or both. For example, the UE 115-a may receive control signaling (e.g., RRC, SIB, DCI, MAC-CE) from the network entity 105-a which indicates the prioritization configuration 335.

In some cases, the UE 115-a may be configured with multiple prioritization configurations 335, and may select which prioritization to use or activate based on signaling from the network entity 105-a or other device, based on certain network conditions, and the like. In some aspects, each prioritization configuration 335 may define different rules or conditions that are used to determine which wireless entities the UE 115-a is expected to prioritize.

For example, in some implementations, a prioritization configuration 335 may include or define a fixed priority between different types of wireless devices. In other words, the prioritization configuration 335 may include or indicate a fixed priority list for initial access (or discovery), where the priority list indicates relative priority metrics or rankings between different types of wireless devices/nodes. In some cases, prioritization configurations 335 associated with fixed priority lists may be indicated by the network entity 105-a (e.g., last-connected gNB) while the UE 115-a is in the RRC connected state, pre-defined by the network, or both.

For instance, a prioritization configuration 335 may include a fixed priority list that causes the UE 115-a to prioritize terrestrial nodes (e.g., network entity 105-a) over satellites 310, and to prioritize satellites 310 over aircraft 305 relays (e.g., Prioritization {terrestrial gNB, satellite, aircraft relay}). By way of another example, another prioritization configuration 335 may include a fixed priority list that causes the UE 115-a to prioritize terrestrial nodes (e.g., network entity 105-a) over aircraft 305 relays, and to prioritize aircraft 305 relays over satellites 310 (e.g., Prioritization {terrestrial gNB, aircraft relay, satellite}). Priority lists associated with fixed prioritization configurations 335 may be extended to different types of non-terrestrial nodes, such as UAVs, HAPs, etc. Moreover, a priority list may include or define different priorities for different types or classes of non-terrestrial nodes, different types/classes of aircraft, different types/classes of satellites, and the like.

In some aspects, the prioritization configuration 335 may cause the UE 115-a to attempt initial access and/or discovery with different types of nodes according to different periodicities or frequencies. For example, the UE 115-a may be configured with a prioritization configuration 335 associated with a fixed priority list that causes the UE 115-a to prioritize terrestrial nodes (e.g., network entity 105-a) over satellites 310, and to prioritize satellites 310 over aircraft 305 relays (e.g., Prioritization {terrestrial gNB, satellite, aircraft relay}). As shown in FIG. 3, the UE 115-a may attempt to perform initial access and/or discovery with the respective devices according to different sets of communication occasions 315 associated with different periodicities 320 based on the prioritization configuration 335. In particular, the prioritization configuration 335 may cause the UE 115-a to perform initial access/discovery with network entities 105 more frequently compared to satellites 310, and to perform initial access/discovery with satellites 310 more frequently compared to aircraft 305.

For instance, the UE 115-a may attempt to perform initial access/discovery with network entities 105 within a first set of communication occasions 315-a associated with a first periodicity. Similarly, the UE 115-a may attempt to perform initial access/discovery with satellites 310 within a second set of communication occasions 315-b associated with a second periodicity 320-b, and may attempt to perform initial access/discovery with satellites 310 within a third set of communication occasions 315-c associated with a third periodicity 320-c. Stated differently, the UE 115-a may monitor for SSBs, discovery messages, or both, from the respective devices according to the different periodicities 320.

In this example, the first periodicity 320-a may be shorter (e.g., more frequent) than the second periodicity 320-b, indicating that the UE 115-a is configured to prioritize connections with the network entities 105 over connections with satellites 310 in accordance with the prioritization configuration 335. Similarly, the second periodicity 320-b may be shorter (e.g., more frequent) than the third periodicity 320-c, indicating that the UE 115-a is configured to prioritize connections with satellites 310 over connections with aircraft 305 in accordance with the prioritization configuration 335. In other words, higher-priority nodes may be associated with lower/shorter periodicities 320, where lower-priority nodes may be associated with higher/longer periodicities 320.

In additional or alternative implementations, some prioritization configurations 335 may include dynamic priorities in which relative priorities of different types of wireless nodes may vary based on certain parameters or characteristics. Parameters or characteristics which may be taken into account with dynamic prioritization configurations 335 may include, but are not limited to, a quantity of aircraft 305 and/or satellites 310 accessible by the UE 115-a, distances between the UE 115-a and the aircraft 305 and/or satellites 310, a quality of communications between the UE 115-a and aircraft 305 and/or satellites 310, or any combination thereof.

For example, in some cases, a prioritization configuration 335 may include a dynamic priority that causes the UE 115-a to prioritize different types of wireless entities based on a quantity (e.g., average quantity, median quantities, estimated quantity) of aircraft 305 (N) within a target area 325 (e.g., target cell radius, target cell area) from the UE 115-a. For instance, as shown in FIG. 3, the quantity of aircraft 305 within the target area 325 is three (e.g., aircraft 305-a, 305-b, and 305-c), as the fourth aircraft 305-d is located outside of the target area 325 (and may therefore be unreachable by the UE 115-a). Moreover, a dynamic prioritization configuration 335 may include rules or conditions that cause the UE 115-a to determine different priorities for different types or classes of non-terrestrial nodes, different types/classes of aircraft, different types/classes of satellites, and the like.

In some implementations, the target area 325 may be defined or determined relative to different devices, geographical locations, etc. In other words, the center of the target area may be a UE 115 or other wireless device, a specific geographical location (e.g., GNSS location area), etc. For example, the UE 115-a may be the center of the target area 325 such that the target area 325 moves along with the UE 115-a.

In some cases, the quantity of aircraft 305 (N) within a target area 325 may be a function of both location and time (e.g., N(location, time)). In other words, the quantity of aircraft 305 within a target area 325 of the UE 115-a may be based on a location of the UE 115-a and a timing associated with the UE 115-a (e.g., time of day). For instance, the quantity of aircraft 305 within a target area 325 of the UE 115-a may be greater during the daytime as compared to the middle of the night when there are less aircraft 305 flying. By way of another example, the quantity of aircraft 305 within a target area 325 may be different when the UE 115-a is located near an airport or in a densely populated city as compared to a rural area.

In some aspects, according to the dynamic prioritization configuration 335, the relative priorities of different types of wireless nodes may be determined by comparing the quantity of aircraft 305 within the target area 325 to a threshold quantity. The threshold quantity may be pre-configured at the UE 115-a, signaled to the UE 115-a (e.g., via RRC signaling), or both. For example, if the quantity of aircraft 305 within the target area 325 is greater than or equal to the threshold quantity (e.g., N(location, time)≥Thresh), then the prioritization configuration 335 may cause the UE 115-a to prioritize aircraft 305 relays over satellites 310 (e.g., prioritize non-terrestrial relay nodes over NTN nodes). Further, if the quantity of aircraft 305 within the target area 325 is less than the threshold quantity (e.g., N(location, time)<Thresh), then the prioritization configuration 335 may cause the UE 115-a to prioritize satellites 310 over aircraft 305 relays (e.g., prioritize NTN nodes over non-terrestrial relay nodes). In such cases, the dynamic prioritization configuration 335 may additionally cause the UE 115-a to prioritize terrestrial nodes (e.g., network entity 105-a) over aircraft 305 and satellites 310, regardless of the quantity of aircraft 305 in the vicinity.

In additional or alternative implementations, a dynamic prioritization configuration 335 may cause the UE 115-a to determine relative priorities between different types of nodes based on distances (e.g., distance metrics) between the UE 115-a and the aircraft 305. For example, the UE 115-a may calculate or estimate distance metrics between the UE 115-a and one or more aircraft 305 (e.g., aircraft 305 within the target area 325), and may be configured to determine relative priorities for aircraft 305 and satellites 310 based on the distance metrics. For instance, the UE 115-a may be configured to prioritize aircraft 305 over satellites 310 if an average distance metric is less than or equal to some distance threshold, and prioritize satellites 310 over aircraft 305 if the average distance metric is greater than the distance threshold.

In some aspects, the target area 325 (e.g., target cell radius), the threshold quantity of aircraft, or both, may be signaled to the UE 115-a, pre-configured at the UE 115-a, defined by the network, or any combination thereof. For example, in some aspects, the dynamic prioritization configuration 335, the target area 325, the threshold quantity, or any combination thereof, may be indicated by the network entity 105-a (e.g., last-connected gNB) while the UE 115-a is in the RRC connected state.

As described herein, the quantity of aircraft 305 within the vicinity of the UE 115-a (e.g., within the target area 325) may vary based on time and location. For example, for the same location, the aircraft 305 density may decrease at night relative to the day time. As such, in some aspects, the UE 115-a may be configured with a model for estimating the quantity of aircraft 305 (e.g., non-terrestrial relay nodes) within the target area. For instance, the UE 115-a may receive control signaling from the network entity 105-a, where the control signaling indicates the dynamic prioritization configuration 335 and a model for estimation of the quantity of aircraft 305 in the target area 325. As such, the UE 115-a may be configured to estimate the quantity of aircraft 305 in the vicinity in accordance with the model, and may determine relative priorities of the different types of nodes based on the estimated quantity of aircraft 305.

In additional or alternative implementations, the network (e.g., network entity 105-a) may be configured to determine/estimate the quantity of aircraft 305 in the target area 325, and may be configured to signal the determined/estimated quantity to the UE 115-a. In some aspects, the UE 115-a may be configured to monitor for signals according to different periodicities 320 based on the relative priorities determined according to the dynamic prioritization configuration 335.

As described herein, the UE 115-a may be configured with multiple prioritization configurations 335. In such cases, the UE 115-a may switch between prioritization configurations 335 based on explicit signaling, or based on certain parameters/conditions being met. For example, If the distance between the UE 115-a and a current GNSS position associated with the UE 115-a (e.g., GNSS position of the UE 115-a when attempting to perform search) and an original GNSS position (e.g., original GNSS position of the UE 115-a when the UE 115-a received the configuration) is greater than some distance threshold, the UE 115-a may be configured to fall back to a fixed prioritization configuration 335 associated with a fixed or default priority list.

In some aspects, the UE 115-a may be configured to establish wireless communications with a respective wireless device (e.g., network entity 105-a, aircraft 305, satellite 310) in accordance with relative prioritizations determined according to the prioritization configuration 335. For instance, in cases where the prioritization configuration 335 causes the UE 115-a to prioritize aircraft 305 over satellites 310, the UE 115-a may be configured to monitor for signals (e.g., SSBs, discovery messages) from aircraft 305. Similarly, in cases where the prioritization configuration 335 causes the UE 115-a to prioritize satellites 310 over aircraft 305, the UE 115-a may be configured to monitor for signals (e.g., SSBs, discovery messages) from satellites 310.

Subsequently, after establishing wireless communications with an aircraft 305 or satellite 310, the UE 115-a may be configured to communicate messages 340 with the respective devices. For example, as shown in FIG. 3, the UE 115-a may communicate one or more messages 340-a with the aircraft 305-b (e.g., non-terrestrial node). By way of another example, the UE 115-a may communicate one or more messages 340-b with the satellite 310-a. In some cases, the aircraft 305/satellite 310 may be configured to relay wireless communications to and from the UE 115-a. For example, an aircraft 305 may be used to relay communications from the UE 115-a to the network entity 105-a, and vice versa. In this regard, the ability of the UE 115-a to communicate with aircraft 305 and satellites 310 may enable the UE 115-a to maintain a network connection even in cases where the UE 115-a would otherwise be out of coverage (e.g., unreachable) with respect to terrestrial nodes, such as the network entity 105-a.

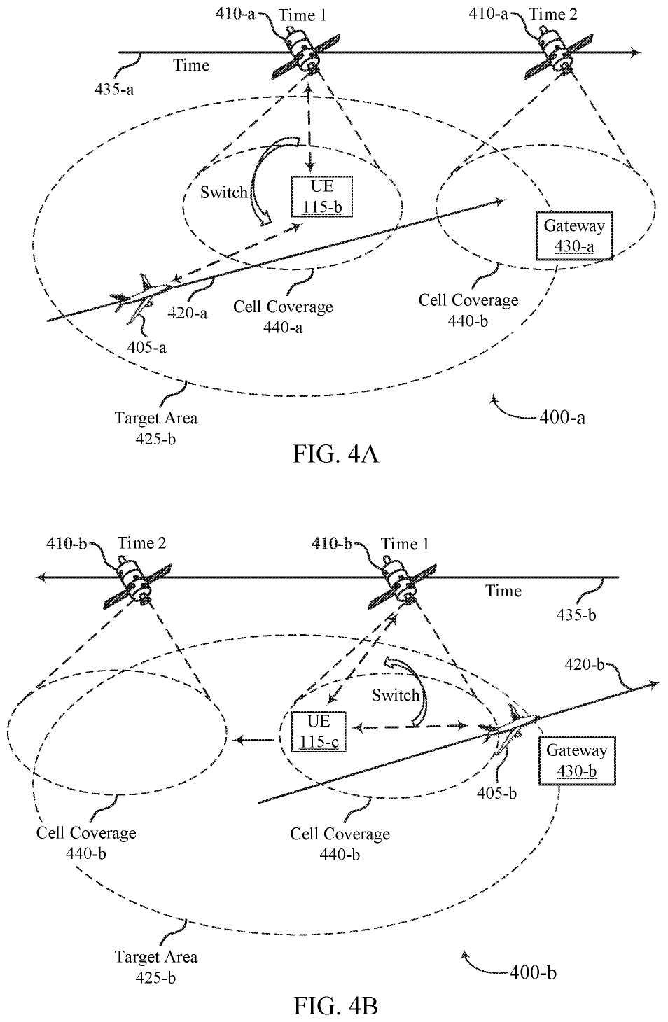

In some cases, due to the movement of satellites 310 and aircraft 305 relative to the UE 115-a, the UE 115-a may be expected to perform handover procedures between two aircraft 305, between two satellites 310, between a satellite 310 and aircraft 305, and the like. Handovers between satellites 310 and aircraft 305 are further shown and described with reference to FIGS. 4A and 4B.

FIGS. 4A and 4B illustrate examples of wireless communications systems 400-a, 400-b that support techniques for joint NTNs and aircraft relaying networks in accordance with one or more aspects of the present disclosure. Aspects of the wireless communications systems 400-a, 400-b may implement, or be implemented by, aspects of the wireless communications system 100, the network architecture 200, the wireless communications system 300, or any combination thereof. In particular, the wireless communications systems 400-a and 400-b illustrate techniques for UEs 115 to perform handover procedures from satellites to aircraft, and from aircraft to satellites, respectively.

In some aspects, techniques described herein may utilize location-based triggering for performing satellite 410 to aircraft 405 switching (e.g., handovers from NTN nodes to non-terrestrial relay nodes). In particular, when there is one or more aircraft 405 supporting relaying service flying over a remote area, remote UE(s) 115 with satellite 410 connections may be switched (or handed over) from a satellite 410 connection to an aircraft 405 relaying connection for data delivery. In such cases, the UEs 115 may be expected to support communications with both NTN node (e.g., satellite 410) and non-terrestrial relay node (e.g., aircraft 405). Such capabilities may be reported to the network, such as through UE capability signaling.

For example, referring to the first wireless communications system 400-a, a UE 115-b may have active communications with a satellite 410-a, where the satellite 410-a is associated with a cell coverage area 440-a, and where the satellite 410-a is moving according to a direction of movement 435-a (e.g., moving from left to right across the page over time). In this example, the UE 115-b may determine that an aircraft 405-a has (or will soon) enter a target area 425-a associated with the UE 115-b, and may therefore perform a handover procedure from the satellite 410-a to the aircraft 405-a. In some cases, the satellite 410-a may obtain information associated with the aircraft 405-a through a gateway 430 (e.g., gateway 430-a, 430-b) or via a direct link between the satellite 410-a and the aircraft 405-a, where such information may be communicated to the UE 115-b to facilitate the handover decision and facilitate communications between the UE 115-b and the aircraft 405-a.

Information associated with the aircraft 405-a that may be communicated to (or identified by) the UE 115-b to facilitate handover procedures may include, but is not limited to, a trajectory 420-a of the aircraft 405-a, a location of the aircraft 405-a, an altitude of the aircraft 405-a, communications parameters for communication with the aircraft 405-a, and the like.

For example, the UE 115-b (or other device) may determine that the aircraft 405-a may be within the target area 425-a for a sufficient time interval (e.g., time interval greater than some threshold time interval) based on the location and the trajectory 420-a of the aircraft, and may therefore perform the handover procedure from the satellite 410-a to the aircraft 405-a. By way of another example, if the UE 115-b determines that the aircraft 405-a will only be within the target area 425-a for a short time interval, as determined by the location and trajectory 420-a of the aircraft 405-a, the UE 115-b may refrain from performing a handover procedure from the satellite 410-a to the aircraft 405-a, and may continue communicating with the satellite 410-a.

Moreover, in some cases, information associated with the satellite 410-a, such as the location and/or direction of movement 435-a of the satellite 410-a, may be used to facilitate handover decisions. For example, as shown in FIG. 4A, the UE 115-b may determine that the UE 115-b may soon be unable to communicate with the satellite 410-a based on the location and/or direction of movement 435-a of the satellite 410-a, and may therefore perform a handover procedure from the satellite 410-a to the aircraft 405-a.

Continuing with reference to the first wireless communications system 400-a, from the perspective of the UE 115-b, performing a handover procedure from the satellite 410-a to the aircraft 405-a may enable power saving at the UE 115-b, as transmissions to the aircraft 405-a may be associated with lower transmit powers as compared to transmissions to the satellite 410-a. The varying transmit powers may be attributable to the fact that the aircraft 405-a may be at an altitude (e.g., 10 km) which is much lower than the altitude of the satellite 410-a (e.g., LEO satellite at 600-2,000 km), and because pathloss of communications is proportional to the square of the distance between devices.

Further, in the context of switching from an aircraft 405 to a satellite 410, techniques described herein may utilize signal quality based (e.g., RSRP-based) triggering. In some cases, when Layer 1 (L1) and/or Layer 3 (L3) measurements of a UE-aircraft link is lower than a threshold, the UE 115 with aircraft 405 relaying service may be handed over from the aircraft 405 relaying connection to a satellite 410 connection for data delivery.

For example, referring to the second wireless communications system 400-b, a UE 115-c may have active communications with an aircraft 405-b. Moreover, the second wireless communications system 400-b may include a satellite 410-b is associated with a cell coverage area 440-b, and where the satellite 410-b is moving according to a direction of movement 435-b (e.g., moving from right to left across the page over time). In this example, the UE 115-c may perform measurements (e.g., RSRP, RSRQ, CQI, SNR, SINR) associated with signals received from the aircraft 405-b, and may determine that the respective measurements fail to satisfy some threshold (e.g., determine that RSRP<Thresh). In this example, the UE 115-c may perform a handover procedure from the aircraft 405-b to the satellite 410-b based on the measurements failing to satisfy the quality/performance threshold(s). Once again, the UE 115-c may be expected to support both NTN and aircraft relaying capabilities, as reported to the network.

Moreover, as noted herein, the aircraft 405-b may be configured to obtain information associated with the satellite 410-b (e.g., through an ATG-gNB link or aircraft-satellite link) in order to facilitate the handover procedure from the aircraft 405-b to the satellite 410-b. Information associated with the satellite 410-b that may be communicated to (or identified by) the UE 115-c to facilitate handover procedures may include, but is not limited to, an altitude or trajectory of the satellite 410-b, a location of the satellite 410-b, a trajectory 420-b of the aircraft 405-b, communications parameters for communication with the satellite 410-b, and the like.

In some implementations, when performing handover procedures between a satellite 410 and an aircraft 405, techniques described herein may additionally or alternatively utilize trajectory (e.g., direction of movement 435), altitude (e.g., LEO, MEO, GEO), and/or location information associated with the satellite 410. For example, in the context of FIG. 4B, when performing a handover from the aircraft 405-b to a satellite 410-b, the UE 115-c may be configured to determine that the satellite 410-b may be able to communicate with the UE 115-c for a sufficient time interval (e.g., time interval greater than some threshold time interval) based on the location and the direction of movement 435-b of the satellite 410-b, and may therefore perform the handover procedure from the aircraft 405-b to the satellite 410-b. In other words, in cases where there are multiple candidate satellites 410, the UE 115-c may be configured to evaluate which satellite 410 to handover to based on the directions of movement 435 (e.g., trajectory, heading) and/or locations of the respective satellites 410.

By way of another example, the UE 115-a may perform a handover procedure from a first satellite 410 (e.g., Satellite 1) to an aircraft 405, and may subsequently perform a handover procedure from the aircraft 405 to a second satellite 410 (e.g., Satellite 2). In this example, the second satellite 410 (Satellite 2) may be different from the first satellite 410 (Satellite 1). Moreover, the UE 115 may determine to handover to the second satellite 410 (rather than back to the first satellite 410) based on the direction of movement 435, altitude, and/or positions of the respective satellites. In particular, the orbit period of the respective satellites 410 (or moving speed relative to the Earth's rotation) may be based on the altitude of the respective satellites 410. The higher the altitude of the satellite 410, the faster the respective satellite 410 moves (e.g., LEO satellites move faster than MEO satellites, which move faster than GEO satellites). Accordingly, in this example, the UE 115 may perform a handover procedure to the second satellite 410 based on the second satellite 410 being associated with a lower altitude and/or higher rate of movement. Due to the lower altitude and/or slower rate of travel, the second satellite 410 may be capable of communicating with the UE 115 for a longer time interval as compared to the first satellite 410.

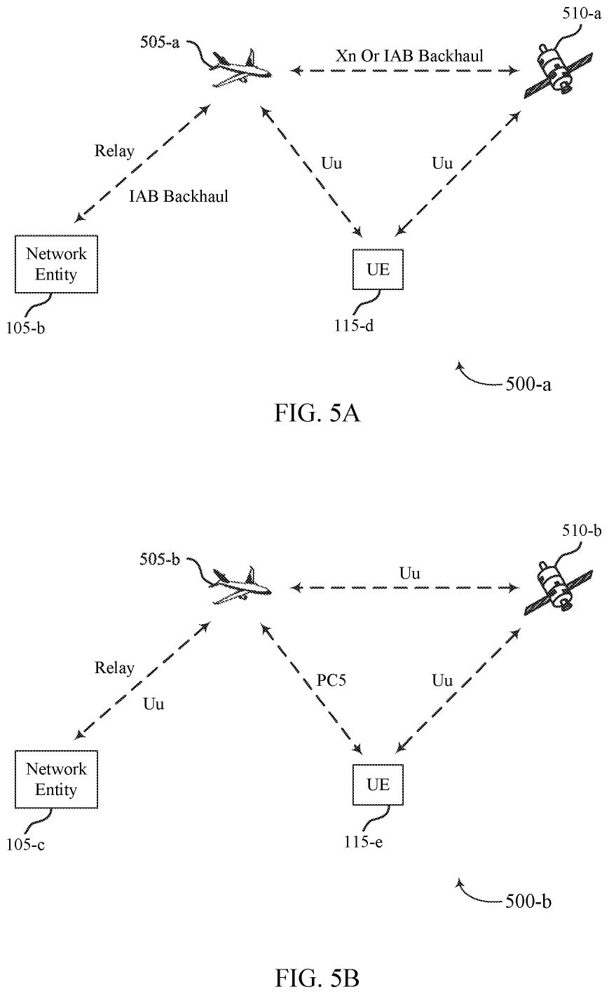

FIGS. 5A and 5B illustrate examples of wireless communications systems 500-a, 500-b that support techniques for joint NTNs and aircraft relaying networks in accordance with one or more aspects of the present disclosure. Aspects of the wireless communications systems 500-a, 500-b may implement, or be implemented by, aspects of the wireless communications system 100, the network architecture 200, the wireless communications system 300, the wireless communications systems 400-a, 400-b, or any combination thereof.

In some implementations, non-terrestrial entities (e.g., aircraft) may be configured to operate as different types of wireless devices. In particular, different types of aircraft may be configured to operate as a gNB (e.g., network entity 105, base station), an IAB node, or a UE 115. Aircraft operating as different types of wireless nodes (e.g., gNB, IAB node, UE 115) may affect the different types of communications links between the respective devices, as well as switching procedures between the respective devices.

For example, the first wireless communications system 500-a may include a UE 115-d, a network entity 105-b, a satellite 510-a, and an aircraft 505-a that is configured to operate as a gNB (e.g., network entity 105) or IAB node. In this example, the UE 115-d may communicate with the aircraft 505-a and the satellite 510-a (and the network entity 105-b) via access links, or Uu links. If the aircraft 505-a is operating as a gNB node, then the interface between the aircraft 505-a and the satellite 510-a may be an Xn interface. Further, if the aircraft 505-a is operating as an IAB node, then the interface between the aircraft 505-a and the satellite 510-a may be an IAB backhaul interface. The IAB-MT feature of the aircraft 505-a may receive some data from the satellite 510-a through IAB backhaul. Moreover, the aircraft 505-a may communicate with the network entity 105-b via a relay or IAB backhaul link.

In some aspects, switching procedures (e.g., handover procedures) at the UE 115-d between the various wireless nodes may utilize mobility and handover procedures as described herein. Additionally, the aircraft 505-a may relay communications between the UE 115-d and the network entity 105-b and/or satellite 510-a via the respective communication links (e.g., aircraft-to-satellite link, or ATG-gNB link).

Further, the second wireless communications system 500-b may include a UE 115-e, a network entity 105-c, a satellite 510-b, and an aircraft 505-b that is configured to operate as a UE 115 node. In this example, the UE 115-e may communicate with the aircraft 505-b and the satellite 510-b via PC5 (e.g., sidelink) and Uu links, respectively. As shown in FIG. 5B, the interface between the aircraft 505-b and the satellite 510-b may be a Uu interface. Similarly, the interface between the aircraft 505-b and the network entity 105-c may be a Uu or relay interface. In the context of the second wireless communications system 500-b, switching procedures (e.g., handover procedures) at the UE 115-e between the various wireless nodes may be from Uu to sidelink relays, or vice versa. Additionally, the aircraft 505-b may relay communications between the UE 115-e and the network entity 105-b and/or satellite 510-b via the respective communication links (e.g., aircraft-to-satellite link, or ATG-gNB link).

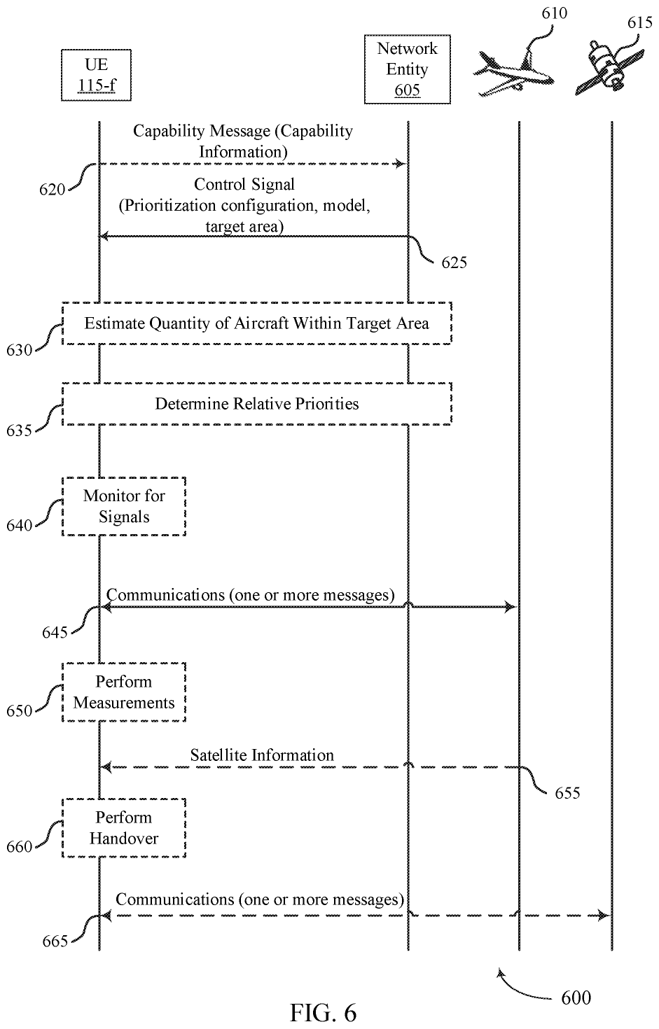

FIG. 6 illustrates an example of a process flow 600 that supports techniques for joint NTNs and aircraft relaying networks in accordance with one or more aspects of the present disclosure. In some examples, the process flow 600 may implement, or be implemented by, aspects of wireless communications systems 100, the network architecture 200, the wireless communications system 300, the wireless communications systems 400-a, 400-b, the wireless communications systems 500-a, 500-b, or any combination thereof. For example, process flow 500 illustrates a UE 115-f receiving a prioritization configuration for determining relative priorities between non-terrestrial entities, as described with reference to FIGS. 1-5.

In some cases, process flow 600 may include a UE 115-F, a network entity 605, an aircraft 610 (e.g., non-terrestrial relay node), and a satellite 615 (e.g., NTN node), which may be examples of corresponding devices as described herein. For example, the UE 115-b, the network entity 605, the aircraft 610, and the satellite 615 illustrated in FIG. 6 may include examples of the UE 115-a, the network entity 105-a, the aircraft 305, and the satellites 310, respectively, as illustrated in FIG. 3. In some instances, the satellite 615 may serve as a bent pipe/transparent satellite 615 which is configured to relay communications between the UE 115-f and the network entity 605. Similarly, the aircraft 610 may be configured to relay wireless communications to and from the UE 115-f.

In some examples, the operations illustrated in process flow 600 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 620, the UE 115-f may output (e.g., transmit), to the network entity 605, capability information (e.g., a capability message) indicating a capability of the UE 115-f to perform wireless communications with the both non-terrestrial relay nodes (e.g., aircraft 610) and NTN nodes (e.g., satellites 615).

At 625, the network entity 605 may output (e.g., transmit), to the UE 115-f, a control signal (e.g., RRC, DSI, SIB, MAC-CE, etc.) indicating one or more prioritization configurations for prioritizing wireless communications/connections between terrestrial nodes (e.g., network entity 605), non-terrestrial relay nodes (e.g., aircraft 610), NTN nodes (e.g., satellites 615), or any combination thereof. Each respective prioritization configuration may include rules or conditions that are used to determine whether what types of wireless nodes the UE 115-f is expected to prioritize in given circumstances. In some cases, the network entity 605 may output the control signal based on receiving the capability information at 620.

As noted herein, prioritization configurations may include fixed prioritization configurations and/or dynamic prioritization configurations. Fixed prioritization configurations may define or include a priority list (e.g., fixed priority list) including relative priorities for terrestrial network entities, non-terrestrial relay nodes, and non-terrestrial network nodes. For instance, a fixed prioritization configuration may cause the UE 115-f to prioritize network entities 605 over satellites 615, and to prioritize satellites 615 over aircraft 610 (e.g., relative priorities associated with the respective devices). In such cases, the UE 115-f may be configured to prioritize different types of wireless devices over others based on a comparison of the relative priorities indicated via priority list.

Further, some prioritization configurations may include dynamic prioritization configurations in which relative priorities of different types of wireless nodes may vary based on certain parameters or characteristics. Parameters or characteristics which may be taken into account with dynamic prioritization configurations may include, but are not limited to, a quantity of aircraft 610 and/or satellites 615 accessible by the UE 115-f, distances between the UE 115-f and the aircraft 610 and/or satellites 615, a quality of communications between the UE 115-f and aircraft 610 and/or satellites 615, or any combination thereof.

In some implementations, the control signaling may indicate various parameters or characteristics associated with the prioritization configurations. Other parameters that may be indicated via the control signaling may include, but are not limited to, a target area associated with the UE 115-f (e.g., target area 325 illustrated in FIG. 3), a threshold quantity of aircraft 610 used to evaluate relative priorities, a model for estimating a quantity of aircraft 610 in the vicinity of the UE 115-f, and the like.

At 630, the UE 115-f, the network entity 605, or both, may determine or estimate a quantity of aircraft 610 within a target area of the UE 115-f. The UE 115-f and/or the network entity 605 may perform the determination/estimation at 630 based on the capability information at 620, the control signal at 625, or both. For example, the UE 115-f may estimate the quantity of aircraft 610 within a target area of the UE 115-f in accordance with a model received via the control signal.

At 635, the UE 115-f, the network entity 605, or both, may determine relative priorities for different types of wireless nodes in accordance with the prioritization configuration. In this regard, the UE 115-f, the network entity 605, or both, may determine the relative priorities based on the capability information at 620, the control signal at 625, the quantity of aircraft 610 within the target area estimated at 630, or any combination thereof.

For example, in the case of a fixed prioritization configuration, the UE 115-f may determine relative priorities of different types of wireless nodes (e.g., terrestrial nodes, non-terrestrial relay nodes, NTN nodes) by comparing priorities within a fixed priority list corresponding to the respective nodes.

By way of another example, in the case of a dynamic prioritization configuration, the UE 115-f may determine relative priorities of different types of wireless nodes by comparing the estimated quantity of aircraft 610 within the target area to a threshold quantity. For instance, if the quantity of aircraft 610 within the target area is greater than or equal to the threshold quantity (e.g., N (location, time)≥Thresh), then the prioritization configuration may cause the UE 115-f to prioritize aircraft 610 relays over satellites 615 (e.g., prioritize non-terrestrial relay nodes over NTN nodes). Further, if the quantity of aircraft 610 within the target area is less than the threshold quantity (e.g., N (location, time)<Thresh), then the prioritization configuration may cause the UE 115-f to prioritize satellites 615 over aircraft 610 relays (e.g., prioritize NTN nodes over non-terrestrial relay nodes).

In some aspects, the threshold quantity of aircraft 610 may be signaled by the network entity 605, pre-configured at the UE 115-f, determined by the network, or any combination thereof. Moreover, in some cases, the threshold quantity may be determined and/or modified based on certain parameters or conditions, such as traffic load, an amount of noise, a priority or quality of service (QOS) associated with communications performed at the UE 115-f, or any combination thereof.

In additional or alternative implementations, a dynamic prioritization configuration may cause the UE 115-f to determine relative priorities between different types of nodes based on distances (e.g., distance metrics) between the UE 115-f and the aircraft 610. For example, the UE 115-f may calculate or estimate distance metrics between the UE 115-f and one or more aircraft 610 (e.g., aircraft 610 within the target area), and may be configured to determine relative priorities for aircraft 610 and satellites 615 based on the distance metrics. For instance, the UE 115-f may be configured to prioritize aircraft 610 over satellites 615 if an average distance metric is less than or equal to some distance threshold, and prioritize satellites 615 over aircraft 610 if the average distance metric is greater than the distance threshold.

At 640, the UE 115-f may monitor for signals (e.g., SSBs, discovery messages, reference signals) from one of the respective wireless nodes based on the determined priorities. For example, in cases where the UE 115-f prioritizes wireless communications/connections with aircraft 610 at 635 (in accordance with the prioritization configuration), the UE 115-f may be configured to monitor for SSBs/discovery messages from the aircraft 610 in order to establish wireless communications with the aircraft 610. In this regard, the UE 115-f may perform the monitoring at 640 based on transmitting the capability information at 620, receiving the control signal at 625, estimating the quantity of aircraft at 630, determining the relative priorities at 635 (e.g., performing the prioritization at 635), or any combination thereof.

At 645, the UE 115-f may communicate one or more messages with a wireless node based on the prioritization configuration. For example, as shown in FIG. 6, the prioritization configuration may cause the UE 115-f to prioritize wireless communications with aircraft 610 over wireless communications with satellites 615, and may therefore communicate one or more messages with the aircraft 610 based on the prioritization (e.g., in accordance with the prioritization configuration). In this regard, the UE 115-f may perform the communications at 645 based on transmitting the capability information at 620, receiving the control signal at 625, estimating the quantity of aircraft at 630, determining the relative priorities at 635 (e.g., performing the prioritization at 635), monitoring for signals from the aircraft 610 at 640, or any combination thereof.

In some implementations, the aircraft 610 may be configured to relay messages to or from the UE 115-f at 645. For example, the aircraft 610 may be configured to receive messages from the UE 115-f and relay/forward the messages to the network entity 605 and/or aircraft 610. Similarly, in other cases, the aircraft 610 may be configured to receive messages from the network entity 605 and/or satellite 615, and relay/forward the messages to the UE 115-f.

While FIG. 6 illustrates an example in which the UE 115-f prioritizes the aircraft 610 over the satellite 615, this is solely for illustrative purposes. For example, in other cases, the prioritization configuration may cause the UE 115-f to prioritize the satellite 615 over the aircraft 610 at 635. In such cases, the UE 115-f may be configured to perform the communications at 645 with the satellite 615.

Moreover, the relative prioritization of different types of wireless nodes may determine the relative order in which the UE 115-f attempts to establish wireless connections. However, the UE 115-f may be configured to establish wireless communications with lower-priority nodes in cases where the UE 115-f is unable to establish communications with higher-priority nodes. For example, at 635, the prioritization configuration may cause the UE 115-f to prioritize the satellite 615 over the aircraft 610. In this example, the UE 115-f may be unable to establish communications with the satellite 615, and may therefore establish communications with the lower-priority aircraft 610.

At 650, the UE 115-f may perform measurements on signals (e.g., messages) received from the aircraft 610. In some cases, L1 and/or L3 measurements performed on signals received from the aircraft 610 may be used to make handover decisions. In particular, L1/L3 measurements may be used to trigger handover procedures from the aircraft 610 to the satellite 615. For example, as described herein with respect to FIG. 4B, the UE 115-f may be configured to perform handover procedure from the aircraft 610 to the satellite 615 if L1/L3 measurements fail to satisfy one or more thresholds (e.g., if RSRP<Thresh).

At 655, the UE 115-f may receive, from the aircraft 610, information associated with the satellite 615 in order to facilitate a handover procedure from the aircraft 610 to the satellite 615. Information associated with the satellite 615 may include, but is not limited to, a location or altitude of the satellite 615, a heading or trajectory of the satellite 615, communications parameters for communication with the satellite 615, or any combination thereof.

At 660, the UE 115-f may perform a handover procedure from the aircraft 610 to the satellite 615. The UE 115-f may perform the handover procedure based on performing the communications at 625, performing the measurements at 650, receiving the information associated with the satellite at 655, or any combination thereof. For example, the UE 115-f may be configured to perform handover procedure from the aircraft 610 to the satellite 615 if L1/L3 measurements fail to satisfy one or more thresholds (e.g., if RSRP<Thresh).

At 665, the UE 115-f may communicate one or more messages with the satellite 615. In particular, the UE 115-f may communicate with the satellite 615 based on performing the handover procedure at 660. Moreover, the UE 115-f may communicate with the satellite 615 based on the information associated with the satellite 615 which was received at 655.

The process flow 600 illustrates a handover procedure from the aircraft 610 to the satellite 615. In additional or alternative implementations, the UE 115-f may be configured to perform a handover procedure from the satellite 615 to the aircraft 610. As described herein with respect to the first wireless communications system 400-a illustrated in FIGS. 4A and 4B, techniques described herein may utilize location-based triggering for performing satellite 615 to aircraft 610 switching. In particular, when there is one or more aircraft 610 supporting relaying service flying over a remote area, remote UE(s) 115 with satellite 615 connections may be switched (or handed over) from a satellite 615 connection to an aircraft 610 relaying connection for data delivery. Moreover, in such cases, the satellite 615 may communicate, to the UE 115-f, information associated with the aircraft 610 in order to facilitate the handover procedure. Information associated with the aircraft 610 may include a location, altitude, and/or trajectory/heading of the aircraft 610, communication parameters for communicating with the aircraft 610, and the like.

Techniques described herein may enable wireless devices (e.g., UE 115-f) to determine what types of non-terrestrial entities that the wireless devices are expected to prioritize in different scenarios. In particular, the prioritization configurations described herein may cause the UE 115-f to prioritize different types of non-terrestrial entities in different situations based on what type of non-terrestrial entity is expected or more likely to exhibit better wireless communication performance with the wireless device. In this regard, techniques described herein may enable the UE 115-f to establish wireless communications with different types of non-terrestrial entities in such a manner as to improve an efficiency and reliability of wireless communications between the UE 115-f and respective non-terrestrial entities.

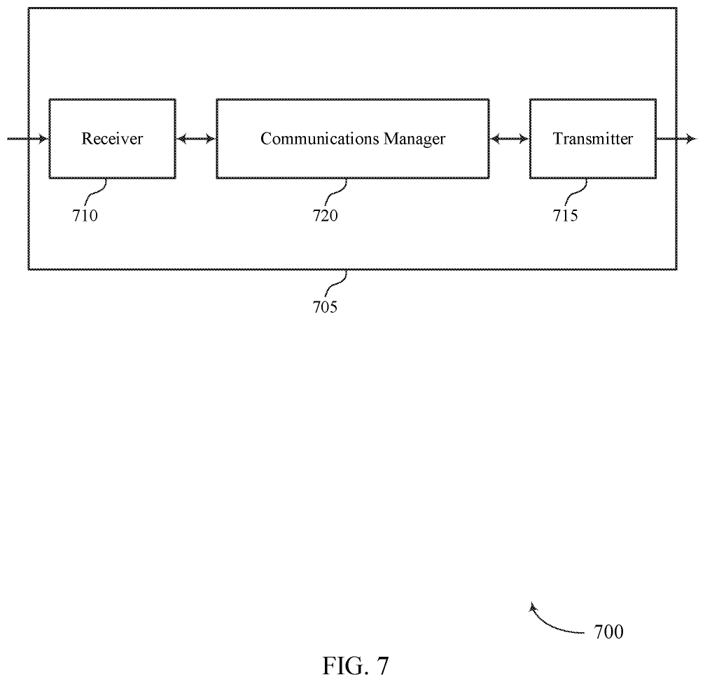

FIG. 7 shows a block diagram 700 of a device 705 that supports techniques for joint NTNs and aircraft relaying networks in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for joint NTNs and aircraft relaying networks). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for joint NTNs and aircraft relaying networks). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for joint NTNs and aircraft relaying networks as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for receiving a control message indicating a prioritization configuration for prioritizing wireless communications between one or more non-terrestrial relay nodes and one or more NTN nodes. The communications manager 720 may be configured as or otherwise support a means for communicating one or more messages based on the prioritization configuration and a quantity of non-terrestrial relay nodes corresponding to a location associated with the UE, a timing associated with the UE, or both.

Additionally, or alternatively, the communications manager 720 may support wireless communication at a UE in accordance with examples as disclosed herein. For example, the communications manager 720 may be configured as or otherwise support a means for performing an access procedure in accordance with a prioritization configuration associated with the access procedure, the prioritization configuration indicating a priority list including respective priorities for terrestrial network entities, non-terrestrial relay nodes, and NTN nodes. The communications manager 720 may be configured as or otherwise support a means for communicating one or more messages with one of the terrestrial network entity, the non-terrestrial relay node, or the NTN node based on the access procedure.

By including or configuring the communications manager 720 in accordance with examples as described herein, the device 705 (e.g., a processor controlling or otherwise coupled with the receiver 710, the transmitter 715, the communications manager 720, or a combination thereof) may support techniques that enable wireless devices (e.g., UEs 115) to determine what types of non-terrestrial entities that the wireless devices are expected to prioritize in different scenarios. In particular, the prioritization configurations described herein may cause wireless devices to prioritize different types of non-terrestrial entities in different situations based on what type of non-terrestrial entity is expected or more likely to exhibit better wireless communication performance with the wireless device. In this regard, techniques described herein may enable wireless devices to establish wireless communications with different types of non-terrestrial entities in such a manner as to improve an efficiency and reliability of wireless communications between the wireless device and respective non-terrestrial entities.

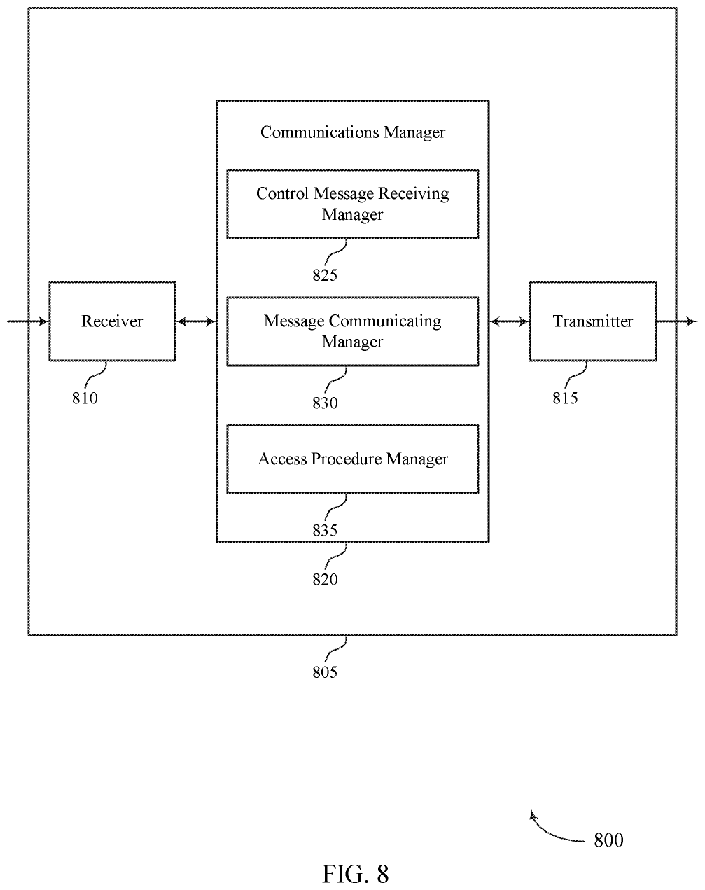

FIG. 8 shows a block diagram 800 of a device 805 that supports techniques for joint NTNs and aircraft relaying networks in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for joint NTNs and aircraft relaying networks). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for joint NTNs and aircraft relaying networks). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for joint NTNs and aircraft relaying networks as described herein. For example, the communications manager 820 may include a control message receiving manager 825, a message communicating manager 830, an access procedure manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The control message receiving manager 825 may be configured as or otherwise support a means for receiving a control message indicating a prioritization configuration for prioritizing wireless communications between one or more non-terrestrial relay nodes and one or more NTN nodes. The message communicating manager 830 may be configured as or otherwise support a means for communicating one or more messages based on the prioritization configuration and a quantity of non-terrestrial relay nodes corresponding to a location associated with the UE, a timing associated with the UE, or both.

Additionally, or alternatively, the communications manager 820 may support wireless communication at a UE in accordance with examples as disclosed herein. The access procedure manager 835 may be configured as or otherwise support a means for performing an access procedure in accordance with a prioritization configuration associated with the access procedure, the prioritization configuration indicating a priority list including respective priorities for terrestrial network entities, non-terrestrial relay nodes, and NTN nodes. The message communicating manager 830 may be configured as or otherwise support a means for communicating one or more messages with one of the terrestrial network entity, the non-terrestrial relay node, or the NTN node based on the access procedure.

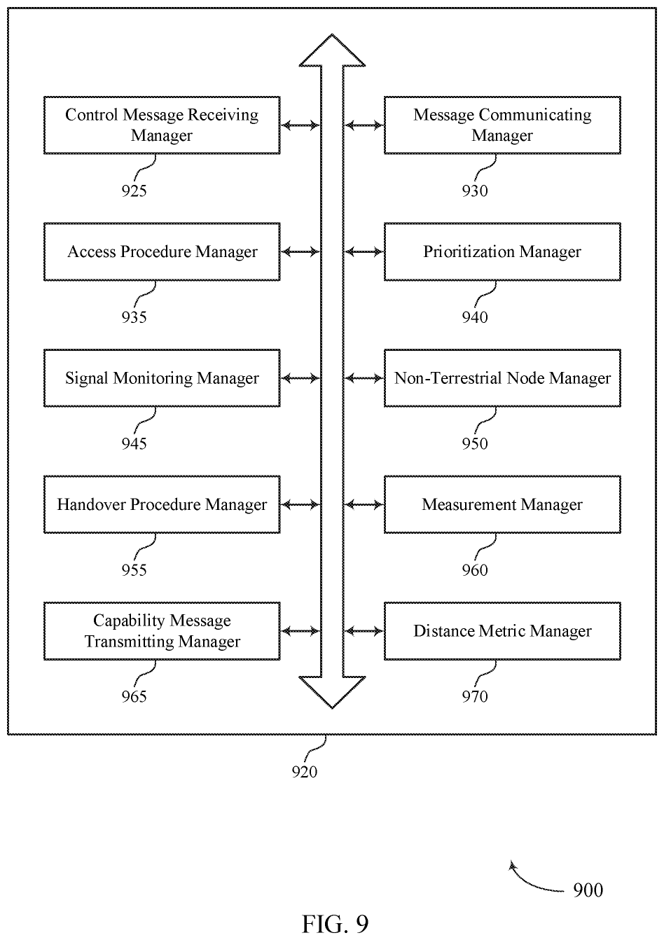

FIG. 9 shows a block diagram 900 of a communications manager 920 that supports techniques for joint NTNs and aircraft relaying networks in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for joint NTNs and aircraft relaying networks as described herein. For example, the communications manager 920 may include a control message receiving manager 925, a message communicating manager 930, an access procedure manager 935, a prioritization manager 940, a signal monitoring manager 945, a non-terrestrial node manager 950, a handover procedure manager 955, a measurement manager 960, a capability message transmitting manager 965, a distance metric manager 970, or any combination thereof. Each of these components may communicate, directly or indirectly, with one another (e.g., via one or more buses).

The communications manager 920 may support wireless communication at a UE in accordance with examples as disclosed herein. The control message receiving manager 925 may be configured as or otherwise support a means for receiving a control message indicating a prioritization configuration for prioritizing wireless communications between one or more non-terrestrial relay nodes and one or more NTN nodes. The message communicating manager 930 may be configured as or otherwise support a means for communicating one or more messages based on the prioritization configuration and a quantity of non-terrestrial relay nodes corresponding to a location associated with the UE, a timing associated with the UE, or both.

In some examples, the prioritization manager 940 may be configured as or otherwise support a means for prioritizing wireless communications with the one or more non-terrestrial relay nodes or the one or more NTN nodes based on the quantity of non-terrestrial relay nodes in accordance with the prioritization configuration, where the one or more messages are communicated with a non-terrestrial relay node of the one or more non-terrestrial relay nodes or an NTN node of the one or more NTN nodes in accordance with the prioritization.

In some examples, the prioritization manager 940 may be configured as or otherwise support a means for prioritizing wireless communications with the one or more non-terrestrial relay nodes or the one or more NTN nodes based on a comparison between the quantity of non-terrestrial relay nodes and a threshold quantity.

In some examples, the prioritization manager 940 may be configured as or otherwise support a means for prioritizing wireless communications with the one or more non-terrestrial relay nodes based on the quantity of non-terrestrial relay nodes being greater than or equal to the threshold quantity. In some examples, the prioritization manager 940 may be configured as or otherwise support a means for prioritizing wireless communications with the one or more NTN nodes based on the quantity of non-terrestrial relay nodes being less than the threshold quantity.

In some examples, the control message receiving manager 925 may be configured as or otherwise support a means for receiving, via the control message, an indication of the threshold quantity, where the comparison is based on the control message.

In some examples, the distance metric manager 970 may be configured as or otherwise support a means for determining a distance metric between the UE and the quantity of non-terrestrial relay nodes within a target area of the location associated with the UE, where the prioritization is based on the distance metric.

In some examples, the control message receiving manager 925 may be configured as or otherwise support a means for receiving, via the control message, an indication of the target area.

In some examples, the signal monitoring manager 945 may be configured as or otherwise support a means for monitoring for a synchronization signal block (SSB), a discovery message, or both, from the one or more non-terrestrial relay nodes or the one or more NTN nodes based on the prioritization configuration and the quantity of non-terrestrial relay nodes, where communicating the one or more messages is based on the monitoring.

In some examples, the control message receiving manager 925 may be configured as or otherwise support a means for receiving, via the control message, an indication of a model for estimation of the quantity of non-terrestrial relay nodes within a target area of the location associated with the UE. In some examples, the non-terrestrial node manager 950 may be configured as or otherwise support a means for estimating the quantity of non-terrestrial relay nodes within the target area of the UE in accordance with the model, where the one or more messages are communicated based on the estimation.

In some examples, the message communicating manager 930 may be configured as or otherwise support a means for communicating the one or more messages with an NTN node of the one or more NTN nodes. In some examples, the handover procedure manager 955 may be configured as or otherwise support a means for performing a handover procedure from the NTN node to a non-terrestrial relay node of the one or more non-terrestrial relay nodes based on the quantity of non-terrestrial relay nodes. In some examples, the message communicating manager 930 may be configured as or otherwise support a means for communicating one or more additional messages with the non-terrestrial relay node based on the handover procedure.

In some examples, communicating the one or more messages includes receiving the one or more messages from the NTN node. In some examples, the one or more messages include information associated with the non-terrestrial relay node. In some examples, the handover procedure is performed based on the information. In some examples, the information includes an identifier associated with the non-terrestrial relay node, a communication parameter for communicating with the non-terrestrial relay node, a heading associated with the non-terrestrial relay node, a location associated with the non-terrestrial relay node, or any combination thereof.

In some examples, communicating the one or more messages includes receiving the one or more messages from the non-terrestrial relay node. In some examples, the one or more messages include information associated with the NTN node. In some examples, the handover procedure is performed based on the information. In some examples, the information includes an identifier associated with the NTN node, communications parameters for communicating with the NTN node, a location associated with the NTN node, or any combination thereof.

In some examples, the message communicating manager 930 may be configured as or otherwise support a means for communicating the one or more messages with a non-terrestrial relay node of the one or more non-terrestrial relay nodes. In some examples, the measurement manager 960 may be configured as or otherwise support a means for performing one or more measurements associated with the one or more messages communicated with the non-terrestrial relay node. In some examples, the handover procedure manager 955 may be configured as or otherwise support a means for performing a handover procedure from the non-terrestrial relay node to an NTN node of the one or more NTN nodes based on the one or more measurements and a measurement threshold. In some examples, the message communicating manager 930 may be configured as or otherwise support a means for communicating one or more additional messages with the NTN node based on the handover procedure.

In some examples, the capability message transmitting manager 965 may be configured as or otherwise support a means for transmitting a capability message indicating a capability of the UE to perform wireless communications with the one or more non-terrestrial relay nodes and the one or more NTN nodes, where the control message indicating the prioritization configuration is received based on the capability message.

In some examples, the message communicating manager 930 may be configured as or otherwise support a means for communicating the one or more messages with an additional wireless device via a relay link provided by a non-terrestrial relay node of the one or more non-terrestrial relay nodes or an NTN node of the one or more NTN nodes. In some examples, the one or more non-terrestrial relay nodes include an aircraft, a UAV, a HAPs device, or any combination thereof. In some examples, the NTN node includes a satellite.

Additionally, or alternatively, the communications manager 920 may support wireless communication at a UE in accordance with examples as disclosed herein. The access procedure manager 935 may be configured as or otherwise support a means for performing an access procedure in accordance with a prioritization configuration associated with the access procedure, the prioritization configuration indicating a priority list including respective priorities for terrestrial network entities, non-terrestrial relay nodes, and NTN nodes. In some examples, the message communicating manager 930 may be configured as or otherwise support a means for communicating one or more messages with one of the terrestrial network entity, the non-terrestrial relay node, or the NTN node based on the access procedure.

In some examples, the prioritization configuration indicates a first priority associated with terrestrial network entities, and the prioritization manager 940 may be configured as or otherwise support a means for prioritizing wireless communications with the terrestrial network entity, the non-terrestrial relay node, or the NTN node based on a comparison of the first priority, the second priority, and the third priority.

In some examples, the signal monitoring manager 945 may be configured as or otherwise support a means for monitoring for an SSB, a discovery message, or both, from the terrestrial network entity, the non-terrestrial relay node, and the NTN node according to respective periodicities that are based on the respective priorities indicated via the prioritization configuration, where communicating the one or more messages is based on the monitored SSBs, discovery messages, or both.

In some examples, the access procedure includes a discovery procedure, an initial access procedure, or both. In some examples, the one or more non-terrestrial relay nodes include an aircraft, a UAV, a HAPs device, or any combination thereof. In some examples, the NTN node includes a satellite.

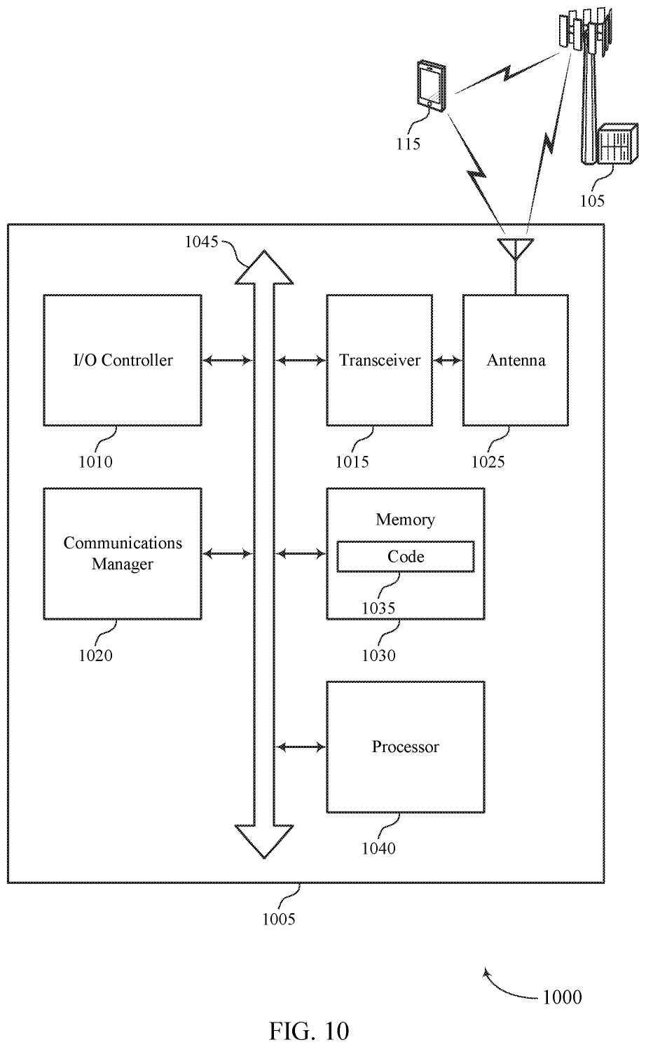

FIG. 10 shows a diagram of a system 1000 including a device 1005 that supports techniques for joint NTNs and aircraft relaying networks in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for joint NTNs and aircraft relaying networks). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for receiving a control message indicating a prioritization configuration for prioritizing wireless communications between one or more non-terrestrial relay nodes and one or more NTN nodes. The communications manager 1020 may be configured as or otherwise support a means for communicating one or more messages based on the prioritization configuration and a quantity of non-terrestrial relay nodes corresponding to a location associated with the UE, a timing associated with the UE, or both.

Additionally, or alternatively, the communications manager 1020 may support wireless communication at a UE in accordance with examples as disclosed herein. For example, the communications manager 1020 may be configured as or otherwise support a means for performing an access procedure in accordance with a prioritization configuration associated with the access procedure, the prioritization configuration indicating a priority list including respective priorities for terrestrial network entities, non-terrestrial relay nodes, and NTN nodes. The communications manager 1020 may be configured as or otherwise support a means for communicating one or more messages with one of the terrestrial network entity, the non-terrestrial relay node, or the NTN node based on the access procedure.

By including or configuring the communications manager 1020 in accordance with examples as described herein, the device 1005 may support techniques that enable wireless devices (e.g., UEs 115) to determine what types of non-terrestrial entities that the wireless devices are expected to prioritize in different scenarios. In particular, the prioritization configurations described herein may cause wireless devices to prioritize different types of non-terrestrial entities in different situations based on what type of non-terrestrial entity is expected or more likely to exhibit better wireless communication performance with the wireless device. In this regard, techniques described herein may enable wireless devices to establish wireless communications with different types of non-terrestrial entities in such a manner as to improve an efficiency and reliability of wireless communications between the wireless device and respective non-terrestrial entities.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of techniques for joint NTNs and aircraft relaying networks as described herein, or the processor 1040 and the memory 1030 may be otherwise configured to perform or support such operations.

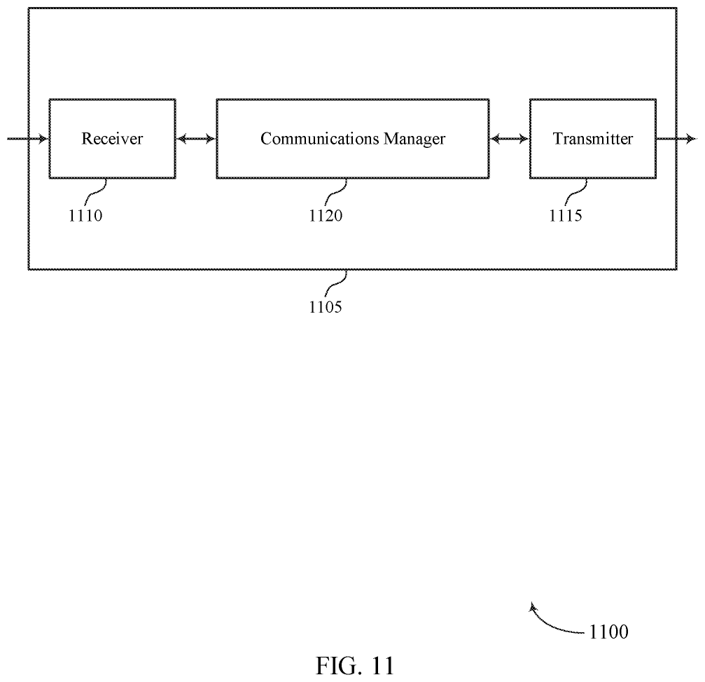

FIG. 11 shows a block diagram 1100 of a device 1105 that supports techniques for joint NTNs and aircraft relaying networks in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of techniques for joint NTNs and aircraft relaying networks as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. For example, the communications manager 1120 may be configured as or otherwise support a means for outputting a control message indicating a prioritization configuration associated with prioritization of wireless communications at a UE, the prioritization configuration indicating relative priorities associated with at least non-terrestrial relay nodes and NTN nodes. The communications manager 1120 may be configured as or otherwise support a means for outputting or obtaining one or more messages via a relay link provided by a non-terrestrial relay node or an NTN node based on the prioritization configuration.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques that enable wireless devices (e.g., UEs 115) to determine what types of non-terrestrial entities that the wireless devices are expected to prioritize in different scenarios. In particular, the prioritization configurations described herein may cause wireless devices to prioritize different types of non-terrestrial entities in different situations based on what type of non-terrestrial entity is expected or more likely to exhibit better wireless communication performance with the wireless device. In this regard, techniques described herein may enable wireless devices to establish wireless communications with different types of non-terrestrial entities in such a manner as to improve an efficiency and reliability of wireless communications between the wireless device and respective non-terrestrial entities.

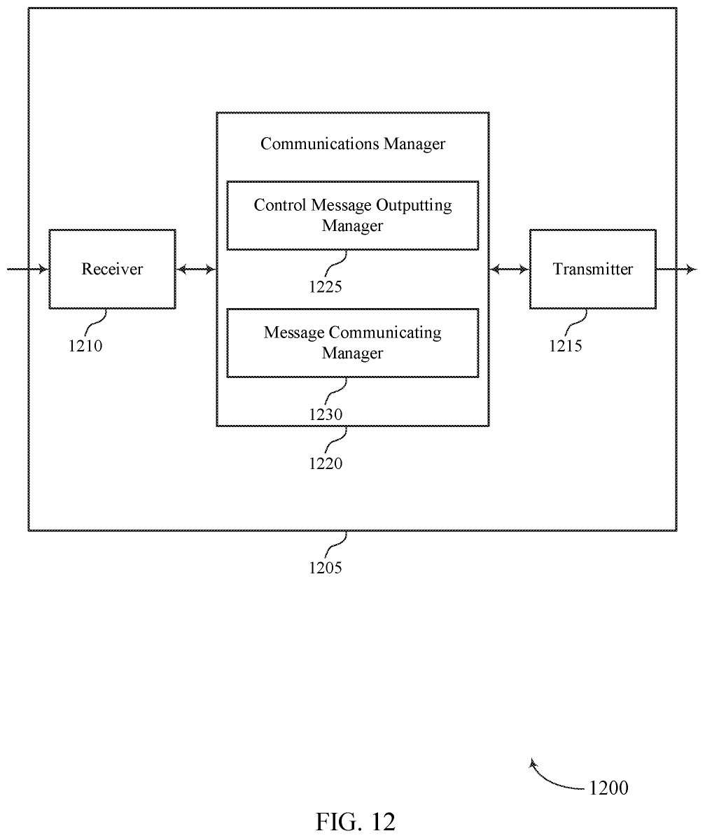

FIG. 12 shows a block diagram 1200 of a device 1205 that supports techniques for joint NTNs and aircraft relaying networks in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for joint NTNs and aircraft relaying networks as described herein. For example, the communications manager 1220 may include a control message outputting manager 1225 a message communicating manager 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. The control message outputting manager 1225 may be configured as or otherwise support a means for outputting a control message indicating a prioritization configuration associated with prioritization of wireless communications at a UE, the prioritization configuration indicating relative priorities associated with at least non-terrestrial relay nodes and NTN nodes. The message communicating manager 1230 may be configured as or otherwise support a means for outputting or obtaining one or more messages via a relay link provided by a non-terrestrial relay node or an NTN node based on the prioritization configuration.

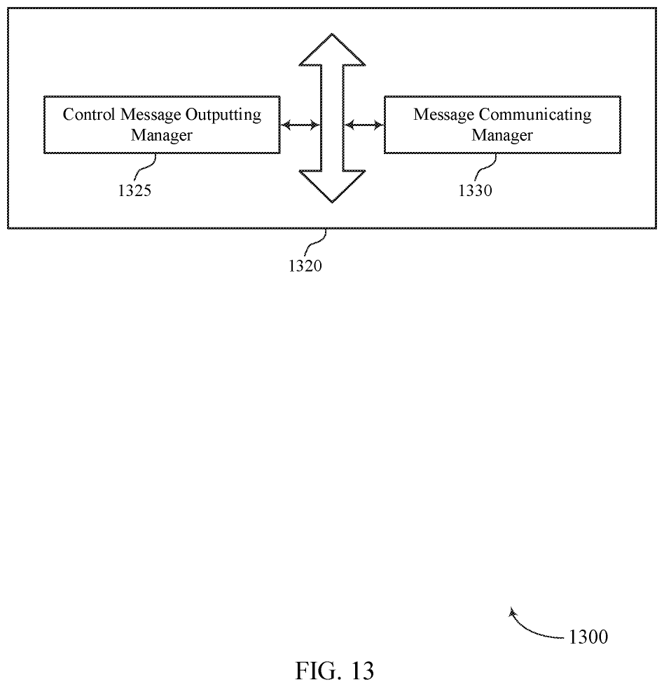

FIG. 13 shows a block diagram 1300 of a communications manager 1320 that supports techniques for joint NTNs and aircraft relaying networks in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for joint NTNs and aircraft relaying networks as described herein. For example, the communications manager 1320 may include a control message outputting manager 1325 a message communicating manager 1330, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The control message outputting manager 1325 may be configured as or otherwise support a means for outputting a control message indicating a prioritization configuration associated with prioritization of wireless communications at a UE, the prioritization configuration indicating relative priorities associated with at least non-terrestrial relay nodes and NTN nodes. The message communicating manager 1330 may be configured as or otherwise support a means for outputting or obtaining one or more messages via a relay link provided by a non-terrestrial relay node or an NTN node based on the prioritization configuration.

In some examples, the control message outputting manager 1325 may be configured as or otherwise support a means for outputting, via the control message, an indication of a threshold quantity of non-terrestrial relay nodes, where the outputting or obtaining the one or more messages is based on a quantity of non-terrestrial relay nodes within a target area of the UE and the threshold quantity of non-terrestrial relay nodes.

In some examples, the control message outputting manager 1325 may be configured as or otherwise support a means for outputting, via the control message, an indication of the target area, where the outputting or obtaining the one or more messages is based on outputting the indication of the target area.

In some examples, the control message outputting manager 1325 may be configured as or otherwise support a means for outputting, via the control message, an indication of a model for estimating the quantity of non-terrestrial relay nodes within the target area of the UE, where the outputting or obtaining the one or more messages is based on outputting the indication of the model.

In some examples, the prioritization configuration indicates a fixed priority list including respective priorities associated with terrestrial network entities, non-terrestrial relay nodes, and NTN nodes. In some examples, the outputting or obtaining the one or more messages is based on the respective priorities. In some examples, the one or more non-terrestrial relay nodes include an aircraft, a UAV, a HAPs device, or any combination thereof. In some examples, the NTN node includes a satellite.

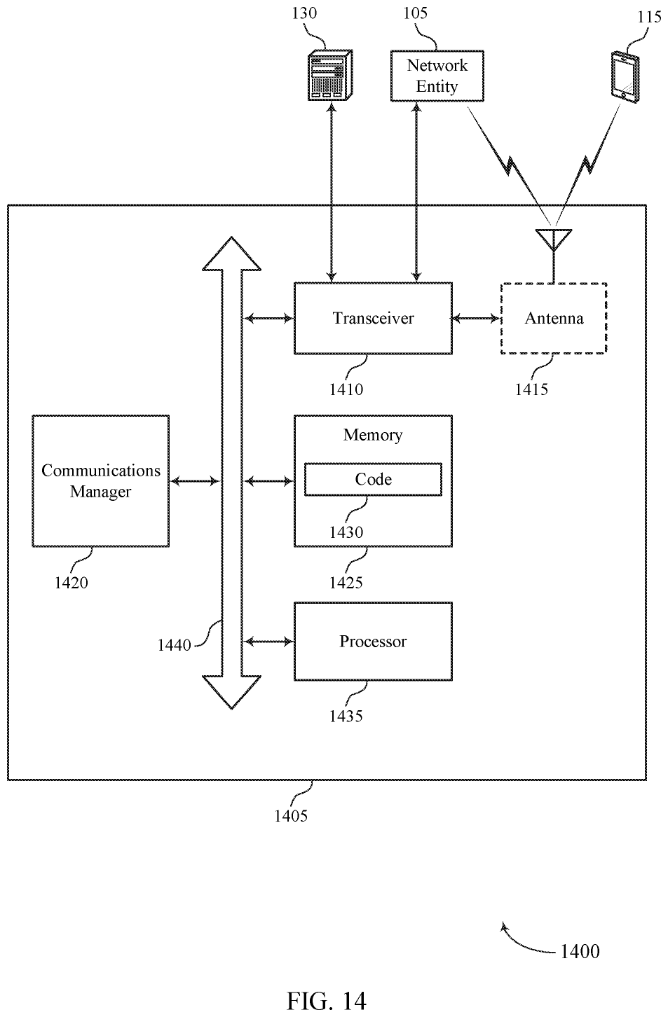

FIG. 14 shows a diagram of a system 1400 including a device 1405 that supports techniques for joint NTNs and aircraft relaying networks in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting techniques for joint NTNs and aircraft relaying networks). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity in accordance with examples as disclosed herein. For example, the communications manager 1420 may be configured as or otherwise support a means for outputting a control message indicating a prioritization configuration associated with prioritization of wireless communications at a UE, the prioritization configuration indicating relative priorities associated with at least non-terrestrial relay nodes and NTN nodes. The communications manager 1420 may be configured as or otherwise support a means for outputting or obtaining one or more messages via a relay link provided by a non-terrestrial relay node or an NTN node based on the prioritization configuration.

By including or configuring the communications manager 1420 in accordance with examples as described herein, the device 1405 may support techniques that enable wireless devices (e.g., UEs 115) to determine what types of non-terrestrial entities that the wireless devices are expected to prioritize in different scenarios. In particular, the prioritization configurations described herein may cause wireless devices to prioritize different types of non-terrestrial entities in different situations based on what type of non-terrestrial entity is expected or more likely to exhibit better wireless communication performance with the wireless device. In this regard, techniques described herein may enable wireless devices to establish wireless communications with different types of non-terrestrial entities in such a manner as to improve an efficiency and reliability of wireless communications between the wireless device and respective non-terrestrial entities.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of techniques for joint NTNs and aircraft relaying networks as described herein, or the processor 1435 and the memory 1425 may be otherwise configured to perform or support such operations.

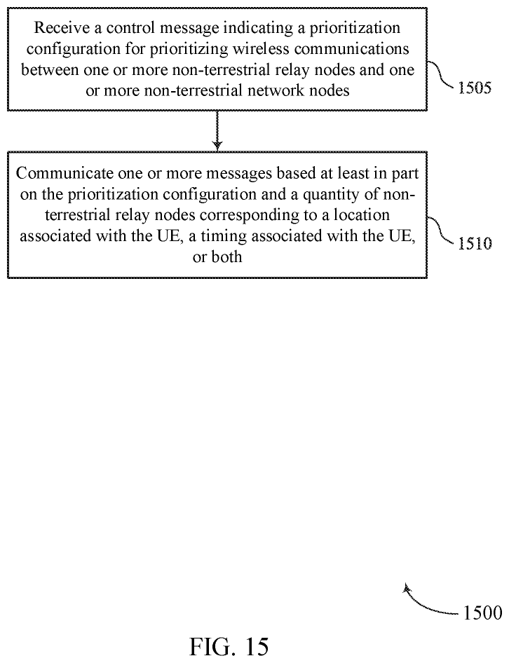

FIG. 15 shows a flowchart illustrating a method 1500 that supports techniques for joint NTNs and aircraft relaying networks in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a control message indicating a prioritization configuration for prioritizing wireless communications between one or more non-terrestrial relay nodes and one or more NTN nodes. The operations of 1505 may be performed in accordance with examples as disclosed herein. In some examples, aspects of the operations of 1505 may be performed by a control message receiving manager 925 as described with reference to FIG. 9.

At 1510, the method may include communicating one or more messages based on the prioritization configuration and a quantity of non-terrestrial relay nodes corresponding to a location associated with the UE, a timing associated with the UE, or both. The operations of 1510 may be performed in accordance with examples as disclosed herein. In some examples, aspects of the operations of 1510 may be performed by a message communicating manager 930 as described with reference to FIG. 9.

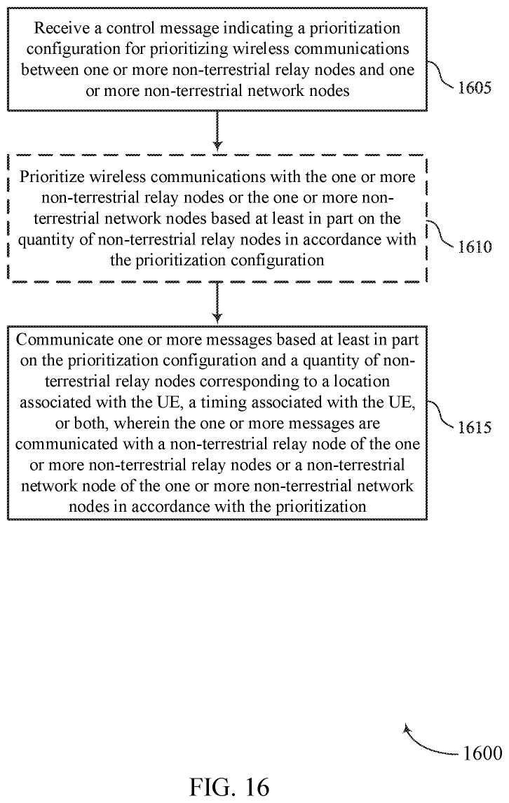

FIG. 16 shows a flowchart illustrating a method 1600 that supports techniques for joint NTNs and aircraft relaying networks in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving a control message indicating a prioritization configuration for prioritizing wireless communications between one or more non-terrestrial relay nodes and one or more NTN nodes. The operations of 1605 may be performed in accordance with examples as disclosed herein. In some examples, aspects of the operations of 1605 may be performed by a control message receiving manager 925 as described with reference to FIG. 9.

At 1610, the method may include prioritizing wireless communications with the one or more non-terrestrial relay nodes or the one or more NTN nodes based on the quantity of non-terrestrial relay nodes in accordance with the prioritization configuration. The operations of 1610 may be performed in accordance with examples as disclosed herein. In some examples, aspects of the operations of 1610 may be performed by a prioritization manager 940 as described with reference to FIG. 9.

At 1615, the method may include communicating one or more messages based on the prioritization configuration and a quantity of non-terrestrial relay nodes corresponding to a location associated with the UE, a timing associated with the UE, or both, where the one or more messages are communicated with a non-terrestrial relay node of the one or more non-terrestrial relay nodes or an NTN node of the one or more NTN nodes in accordance with the prioritization. The operations of 1615 may be performed in accordance with examples as disclosed herein. In some examples, aspects of the operations of 1615 may be performed by a message communicating manager 930 as described with reference to FIG. 9.

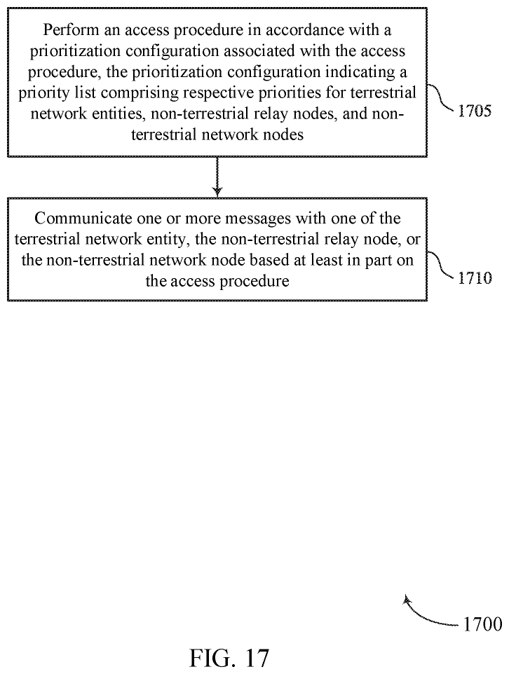

FIG. 17 shows a flowchart illustrating a method 1700 that supports techniques for joint NTNs and aircraft relaying networks in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include performing an access procedure in accordance with a prioritization configuration associated with the access procedure, the prioritization configuration indicating a priority list including respective priorities for terrestrial network entities, non-terrestrial relay nodes, and NTN nodes. The operations of 1705 may be performed in accordance with examples as disclosed herein. In some examples, aspects of the operations of 1705 may be performed by an access procedure manager 935 as described with reference to FIG. 9.

At 1710, the method may include communicating one or more messages with one of the terrestrial network entity, the non-terrestrial relay node, or the NTN node based on the access procedure. The operations of 1710 may be performed in accordance with examples as disclosed herein. In some examples, aspects of the operations of 1710 may be performed by a message communicating manager 930 as described with reference to FIG. 9.

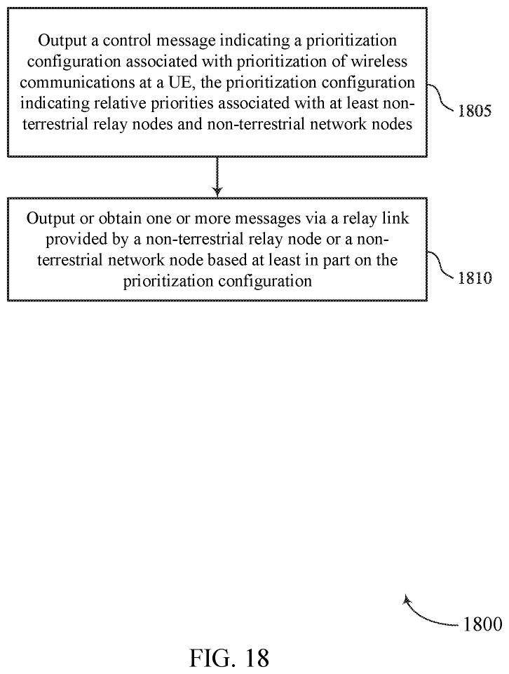

FIG. 18 shows a flowchart illustrating a method 1800 that supports techniques for joint NTNs and aircraft relaying networks in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include outputting a control message indicating a prioritization configuration associated with prioritization of wireless communications at a UE, the prioritization configuration indicating relative priorities associated with at least non-terrestrial relay nodes and NTN nodes. The operations of 1805 may be performed in accordance with examples as disclosed herein. In some examples, aspects of the operations of 1805 may be performed by a control message outputting manager 1325 as described with reference to FIG. 13.

At 1810, the method may include outputting or obtaining one or more messages via a relay link provided by a non-terrestrial relay node or an NTN node based on the prioritization configuration. The operations of 1810 may be performed in accordance with examples as disclosed herein. In some examples, aspects of the operations of 1810 may be performed by a message communicating manager 1330 as described with reference to FIG. 13.

The following provides an overview of aspects of the present disclosure:

Aspect 1: A method for wireless communication at a UE, comprising: receiving a control message indicating a prioritization configuration for prioritizing wireless communications between one or more non-terrestrial relay nodes and one or more NTN nodes; and communicating one or more messages based at least in part on the prioritization configuration and a quantity of non-terrestrial relay nodes corresponding to a location associated with the UE, a timing associated with the UE, or both.

Aspect 2: The method of aspect 1, further comprising: prioritizing wireless communications with the one or more non-terrestrial relay nodes or the one or more NTN nodes based at least in part on the quantity of non-terrestrial relay nodes in accordance with the prioritization configuration, wherein the one or more messages are communicated with a non-terrestrial relay node of the one or more non-terrestrial relay nodes or an NTN node of the one or more NTN nodes in accordance with the prioritization.

Aspect 3: The method of aspect 2, the prioritizing further comprising: prioritizing wireless communications with the one or more non-terrestrial relay nodes or the one or more NTN nodes based at least in part on a comparison between the quantity of non-terrestrial relay nodes and a threshold quantity.

Aspect 4: The method of aspect 3, the prioritizing further comprising: prioritizing wireless communications with the one or more non-terrestrial relay nodes based on the quantity of non-terrestrial relay nodes being greater than or equal to the threshold quantity; and prioritizing wireless communications with the one or more NTN nodes based on the quantity of non-terrestrial relay nodes being less than the threshold quantity.

Aspect 5: The method of any of aspects 3 through 4, further comprising: receiving, via the control message, an indication of the threshold quantity, wherein the comparison is based at least in part on the control message.

Aspect 6: The method of any of aspects 2 through 5, further comprising: determining a distance metric between the UE and the quantity of non-terrestrial relay nodes within a target area of the location associated with the UE, wherein the prioritization is based at least in part on the distance metric.

Aspect 7: The method of aspect 6, further comprising: receiving, via the control message, an indication of the target area.

Aspect 8: The method of any of aspects 1 through 7, further comprising: monitoring for a synchronization signal block, a discovery message, or both, from the one or more non-terrestrial relay nodes or the one or more NTN nodes based at least in part on the prioritization configuration and the quantity of non-terrestrial relay nodes, wherein communicating the one or more messages is based at least in part on the monitoring.

Aspect 9: The method of any of aspects 1 through 8, further comprising: receiving, via the control message, an indication of a model for estimation of the quantity of non-terrestrial relay nodes within a target area of the location associated with the UE; and estimating the quantity of non-terrestrial relay nodes within the target area of the UE in accordance with the model, wherein the one or more messages are communicated based at least in part on the estimation.

Aspect 10: The method of any of aspects 1 through 9, further comprising: communicating the one or more messages with an NTN node of the one or more NTN nodes: performing a handover procedure from the NTN node to a non-terrestrial relay node of the one or more non-terrestrial relay nodes based at least in part on the quantity of non-terrestrial relay nodes; and communicating one or more additional messages with the non-terrestrial relay node based at least in part on the handover procedure.

Aspect 11: The method of aspect 10, wherein communicating the one or more messages comprises receiving the one or more messages from the NTN node, the one or more messages comprise information associated with the non-terrestrial relay node, the handover procedure is performed based at least in part on the information, and the information comprises an identifier associated with the non-terrestrial relay node, a communication parameter for communicating with the non-terrestrial relay node, a heading associated with the non-terrestrial relay node, a location associated with the non-terrestrial relay node, or any combination thereof.

Aspect 12: The method of aspect 10, wherein communicating the one or more messages comprises receiving the one or more messages from the NTN node.

Aspect 13: The method of aspect 10, wherein the one or more messages comprise information associated with the non-terrestrial relay node.

Aspect 14: The method of aspect 10, wherein the handover procedure is performed based at least in part on the information.

Aspect 15: The method of aspect 10, wherein the information comprises an identifier associated with the non-terrestrial relay node, a communication parameter for communicating with the non-terrestrial relay node, a heading associated with the non-terrestrial relay node, a location associated with the non-terrestrial relay node, or any combination thereof.

Aspect 16: The method of any of aspects 1 through 15, further comprising: communicating the one or more messages with a non-terrestrial relay node of the one or more non-terrestrial relay nodes: performing one or more measurements associated with the one or more messages communicated with the non-terrestrial relay node: performing a handover procedure from the non-terrestrial relay node to an NTN node of the one or more NTN nodes based at least in part on the one or more measurements and a measurement threshold; and communicating one or more additional messages with the NTN node based at least in part on the handover procedure.

Aspect 17: The method of any of aspects 1 through 16, further comprising: transmitting a capability message indicating a capability of the UE to perform wireless communications with the one or more non-terrestrial relay nodes and the one or more NTN nodes, wherein the control message indicating the prioritization configuration is received based at least in part on the capability message.

Aspect 18: The method of any of aspects 1 through 17, further comprising: communicating the one or more messages with an additional wireless device via a relay link provided by a non-terrestrial relay node of the one or more non-terrestrial relay nodes or an NTN node of the one or more NTN nodes.

Aspect 19: The method of any of aspects 1 through 18, wherein the one or more non-terrestrial relay nodes comprise an aircraft, a UAV, a HAP device, or any combination thereof, and the NTN node comprises a satellite.

Aspect 20: The method of any of aspects 1 through 18, wherein the one or more non-terrestrial relay nodes comprise an aircraft, and the NTN node comprises a satellite.

Aspect 21: The method of any of aspects 1 through 18, wherein the one or more non-terrestrial relay nodes comprise a UAV, and the NTN node comprises a satellite.

Aspect 22: The method of any of aspects 1 through 18, wherein the one or more non-terrestrial relay nodes comprise a HAP device, and the NTN node comprises a satellite.

Aspect 23: A method for wireless communication at a UE, comprising: performing an access procedure in accordance with a prioritization configuration associated with the access procedure, the prioritization configuration indicating a priority list comprising respective priorities for terrestrial network entities, non-terrestrial relay nodes, and NTN nodes; and communicating one or more messages with one of the terrestrial network entity, the non-terrestrial relay node, or the NTN node based at least in part on the access procedure.

Aspect 24: The method of aspect 23, wherein the prioritization configuration indicates a first priority associated with terrestrial network entities, a second priority associated with non-terrestrial relay nodes, and a third priority associated with NTN nodes, the method further comprising: prioritizing wireless communications with the terrestrial network entity, the non-terrestrial relay node, or the NTN node based at least in part on a comparison of the first priority, the second priority, and the third priority.

Aspect 25: The method of any of aspects 23 through 24, further comprising: monitoring for a synchronization signal block, a discovery message, or both, from the terrestrial network entity, the non-terrestrial relay node, and the NTN node according to respective periodicities that are based at least in part on the respective priorities indicated via the prioritization configuration, wherein communicating the one or more messages is based at least in part on the monitored synchronization signal blocks, discovery messages, or both.

Aspect 26: The method of any of aspects 23 through 24, further comprising:

monitoring for a synchronization signal block from the terrestrial network entity, the non-terrestrial relay node, and the NTN node according to respective periodicities that are based at least in part on the respective priorities indicated via the prioritization configuration, wherein communicating the one or more messages is based at least in part on the monitored synchronization signal blocks.

Aspect 27: The method of any of aspects 23 through 24, further comprising: monitoring for a discovery message from the terrestrial network entity, the non-terrestrial relay node, and the NTN node according to respective periodicities that are based at least in part on the respective priorities indicated via the prioritization configuration, wherein communicating the one or more messages is based at least in part on the monitored discovery messages.

Aspect 28: The method of any of aspects 23 through 25, wherein the access procedure comprises a discovery procedure, an initial access procedure, or both.

Aspect 29: The method of any of aspects 23 through 28, wherein the one or more non-terrestrial relay nodes comprise an aircraft, a UAV, a HAP device, or any combination thereof, and the NTN node comprises a satellite.

Aspect 30: A method for wireless communication at a network entity, comprising: outputting a control message indicating a prioritization configuration associated with prioritization of wireless communications at a UE, the prioritization configuration indicating relative priorities associated with at least non-terrestrial relay nodes and NTN nodes; and outputting or obtaining one or more messages via a relay link provided by a non-terrestrial relay node or an NTN node based at least in part on the prioritization configuration.

Aspect 31: The method of aspect 30, further comprising: outputting, via the control message, an indication of a threshold quantity of non-terrestrial relay nodes, wherein the outputting or obtaining the one or more messages is based at least in part on a quantity of non-terrestrial relay nodes within a target area of the UE and the threshold quantity of non-terrestrial relay nodes.

Aspect 32: The method of aspect 31, further comprising: outputting, via the control message, an indication of the target area, wherein the outputting or obtaining the one or more messages is based at least in part on outputting the indication of the target area.

Aspect 33: The method of any of aspects 31 through 32, further comprising: outputting, via the control message, an indication of a model for estimating the quantity of non-terrestrial relay nodes within the target area of the UE, wherein the outputting or obtaining the one or more messages is based at least in part on outputting the indication of the model.

Aspect 34: The method of any of aspects 30 through 33, wherein the prioritization configuration indicates a fixed priority list comprising respective priorities associated with terrestrial network entities, non-terrestrial relay nodes, and NTN nodes, the outputting or obtaining the one or more messages is based at least in part on the respective priorities.

Aspect 35: The method of any of aspects 30 through 34, wherein the one or more non-terrestrial relay nodes comprise an aircraft, a UAV, a HAP device, or any combination thereof, and the NTN node comprises a satellite.

Aspect 36: An apparatus for wireless communication at a UE, comprising a processor: memory coupled with the processor; and instructions stored in the memory and executable by the processor to perform a method of any of aspects 1 through 19.

Aspect 37: An apparatus for wireless communication at a UE, comprising at least one means for performing a method of any of aspects 1 through 19.

Aspect 38: A non-transitory computer-readable medium storing code for wireless communication at a UE, the code comprising instructions executable by a processor to perform a method of any of aspects 1 through 19.

Aspect 39: An apparatus for wireless communication at a UE, comprising a processor and memory coupled with the processor, the processor configured to cause the apparatus to perform a method of any of aspects 23 through 29.

Aspect 40: An apparatus for wireless communication at a UE, comprising at least one means for performing a method of any of aspects 23 through 29.

Aspect 41: A non-transitory computer-readable medium storing code for wireless communication at a UE, the code comprising instructions executable by a processor to perform a method of any of aspects 23 through 29.

Aspect 42: An apparatus for wireless communication at a network entity, comprising a processor and memory coupled with the processor, the processor configured to perform a method of any of aspects 30 through 35.

Aspect 43: An apparatus for wireless communication at a network entity, comprising at least one means for performing a method of any of aspects 30 through 35.

Aspect 44: A non-transitory computer-readable medium storing code for wireless communication at a network entity, the code comprising instructions executable by a processor to perform a method of any of aspects 30 through 35.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor; and
memory coupled with the processor, the processor configured to:
receive a control message that indicates a prioritization configuration to prioritize wireless communications between one or more non-terrestrial relay nodes and one or more non-terrestrial network (NTN) nodes; and
communicate one or more messages based at least in part on the prioritization configuration and a quantity of non-terrestrial relay nodes associated with to a location associated with the UE, a timing associated with the UE, or both.

2. The apparatus of claim 1, wherein the processor is further configured to:
prioritize wireless communications with the one or more non-terrestrial relay nodes or the one or more NTN nodes based at least in part on the quantity of non-terrestrial relay nodes in accordance with the prioritization configuration, wherein the one or more messages are communicated with a non-terrestrial relay node of the one or more non-terrestrial relay nodes or a NTN node of the one or more NTN nodes in accordance with the prioritization.

3. The apparatus of claim 2, wherein the processor is further configured to:
prioritize wireless communications with the one or more non-terrestrial relay nodes or the one or more NTN nodes based at least in part on a comparison between the quantity of non-terrestrial relay nodes and a threshold quantity.

4. The apparatus of claim 3, wherein the processor is further configured to:
prioritize wireless communications with the one or more non-terrestrial relay nodes based at least in part on the quantity of non-terrestrial relay nodes being greater than or equal to the threshold quantity; and
prioritize wireless communications with the one or more NTN nodes based at least in part on the quantity of non-terrestrial relay nodes being less than the threshold quantity.

5. The apparatus of claim 3, further comprising:
an antenna array configured to receive, via the control message, an indication of the threshold quantity, wherein the comparison is based at least in part on the control message.

6. The apparatus of claim 2, wherein the processor is further configured to:
determine a distance metric between the UE and the quantity of non-terrestrial relay nodes within a target area of the location associated with the UE, wherein the prioritization is based at least in part on the distance metric.

7. The apparatus of claim 6, wherein the processor is further configured to:
receive, via the control message, an indication of the target area.

8. The apparatus of claim 1, wherein the processor is further configured to:
monitor for a synchronization signal block, a discovery message, or both, from the one or more non-terrestrial relay nodes or the one or more NTN nodes based at least in part on the prioritization configuration and the quantity of non-terrestrial relay nodes.

9. The apparatus of claim 1, wherein the processor is further configured to:
receive, via the control message, an indication of a model for estimation of the quantity of non-terrestrial relay nodes within a target area of the location associated with the UE; and
estimate the quantity of non-terrestrial relay nodes within the target area of the UE in accordance with the model, wherein the one or more messages are communicated based at least in part on the estimation.

10. The apparatus of claim 1, wherein the processor is further configured to:
communicate the one or more messages with a NTN node of the one or more NTN nodes;
perform a handover procedure from the NTN node to a non-terrestrial relay node of the one or more non-terrestrial relay nodes based at least in part on the quantity of non-terrestrial relay nodes; and
communicate one or more additional messages with the non-terrestrial relay node based at least in part on the handover procedure.

11. The apparatus of claim 10, wherein, to communicate the one or more messages, the processor is configured to:
receive the one or more messages from the NTN node, wherein the one or more messages comprise information associated with the non-terrestrial relay node, wherein the handover procedure is performed based at least in part on the information, and wherein the information comprises an identifier associated with the non-terrestrial relay node, a communication parameter for communications with the non-terrestrial relay node, a heading associated with the non-terrestrial relay node, a location associated with the non-terrestrial relay node, or any combination thereof.

12. The apparatus of claim 10, wherein the processor is further configured to:
communicate the one or more messages with a non-terrestrial relay node of the one or more non-terrestrial relay nodes;
perform one or more measurements associated with the one or more messages communicated with the non-terrestrial relay node;
perform a handover procedure from the non-terrestrial relay node to a NTN node of the one or more NTN nodes based at least in part on the one or more measurements and a measurement threshold; and
communicate one or more additional messages with the NTN node based at least in part on the handover procedure.

13. The apparatus of claim 12, wherein, to communicate the one or more messages, the processor is configured to:
receive the one or more messages from the non-terrestrial relay node, wherein the one or more messages comprise information associated with the NTN node, wherein the handover procedure is performed based at least in part on the information, and wherein the information comprises an identifier associated with the NTN node, communications parameters for communications with the NTN node, a location associated with the NTN node, or any combination thereof.

14. The apparatus of claim 1, wherein the processor is further configured to:
transmit an indication of a capability of the UE to perform wireless communications with the one or more non-terrestrial relay nodes and the one or more NTN nodes, wherein the control message is received based at least in part on the capability message.

15. The apparatus of claim 1, wherein the processor is further configured to:
communicate the one or more messages with an additional wireless device via a relay link provided by a non-terrestrial relay node of the one or more non-terrestrial relay nodes or a NTN node of the one or more NTN nodes.

16. The apparatus of claim 1, wherein the one or more non-terrestrial relay nodes comprise an aircraft, an unmanned aerial vehicle, a high-altitude platform device, or any combination thereof, and wherein the NTN node comprises a satellite.

17. An apparatus for wireless communication at a user equipment (UE), comprising:
a processor; and
memory coupled with the processor, the processor configured to:
perform an access procedure in accordance with a prioritization configuration associated with the access procedure, where the prioritization configuration indicates a priority list comprising respective priorities for terrestrial network entities, non-terrestrial relay nodes, and non-terrestrial network (NTN) nodes; and
communicate one or more messages with one of the terrestrial network entity, the non-terrestrial relay node, or the NTN node based at least in part on the access procedure.

18. The apparatus of claim 17, wherein the prioritization configuration indicates a first priority associated with terrestrial network entities, a second priority associated with non-terrestrial relay nodes, and a third priority associated with NTN nodes, wherein the processor is further configured to:
prioritize wireless communications with the terrestrial network entity, the non-terrestrial relay node, or the NTN node based at least in part on a comparison of the first priority, the second priority, and the third priority.

19-21. (canceled)

22. An apparatus for wireless communication at a network entity, comprising:
a processor; and
memory coupled with the processor, the processor configured to:
output a control message that indicates a prioritization configuration associated with prioritization of wireless communications at a user equipment (UE), where the prioritization configuration indicates relative priorities associated with at least non-terrestrial relay nodes and non-terrestrial network (NTN) nodes; and
output or obtain one or more messages via a relay link provided by a non-terrestrial relay node or a non-terrestrial network (NTN) node based at least in part on the prioritization configuration.

23. The apparatus of claim 22, wherein the processor is further configured to:
output, via the control message, an indication of a threshold quantity of non-terrestrial relay nodes, wherein the one or more messages is outputted or obtained is based at least in part on a quantity of non-terrestrial relay nodes within a target area of the UE and the threshold quantity of non-terrestrial relay nodes.

24-30. (canceled)
